(19) United States
(12) Patent Application Publication
(10) Pub. No.: US 2016/0282117 A1
(43) Pub. Date: Sep. 29, 2016

(54) ANGULAR VELOCITY DETECTION ELEMENT, ANGULAR VELOCITY DETECTION DEVICE, ELECTRONIC APPARATUS, AND MOVING OBJECT

(71) Applicant: Seiko Epson Corporation, Tokyo (JP)

(72) Inventor: Keiji NAKAGAWA, Minowa (JP)

(21) Appl. No.: 15/073,742

(22) Filed: Mar. 18, 2016

(30) Foreign Application Priority Data
Mar. 23, 2015 (JP) 2015-059146

(51) Int. Cl. G01C 19/5642

(52) U.S. Cl. CPC G01C 19/5642

(57) ABSTRACT

A gyro element includes a base section, a pair of drive arms connected to the base section, and a detection section adapted to detect an angular velocity applied in a state in which the drive arms are flexurally vibrated in a drive vibration mode, and the drive arms vibrate in phase in the in-plane direction of the base section 21, and vibrate in reverse phase in a thickness direction of the base section 21.

### BACKGROUND

1. Technical Field

The present invention relates to an angular velocity detection element, an angular velocity detection device, an electronic apparatus, and a moving object.

2. Related Art

In the past, as a gyro element for detecting an angular velocity, there has been known such a gyro element as described in JP-A-2013-205329 (Document 1). The gyro element described in Document 1 has a base section, a pair of drive arms extending from the base section in one direction along a Y axis, and a pair of detection arms extending from the base section in the other direction along the Y axis. In this gyro element, when acceleration around the Y axis is applied in the state in which the pair of drive arms are driven in an X-axis inverse-phase mode, a vibration in a detection vibration mode is excited in the pair of detection arms, and it is possible to detect the angular velocity around the Y axis based on a signal (a charge) generated by the vibration.

Here, it is general for the outer shape of the gyro element to be obtained by patterning a quartz crystal substrate using a photolithography technique and an etching technique. Specifically, by forming masks corresponding to the outer shape on an upper surface and a lower surface of the quartz crystal substrate, and then etching the quartz crystal substrate via the masks, the outer shape of the gyro element can be obtained. However, in such a method, there is a problem that the masks on the upper and lower sides are shifted from each other, and thus the cross-sectional shapes of the drive arms become different from design shapes. Incidentally, this problem is difficult to avoid in view of the accuracy of a device for forming the masks.

In the gyro element in which the mask displacement has occurred, a vibration in a Z-axis in-phase mode is coupled to the vibration of the X-axis inverse-phase mode in the drive vibration mode, the detection arms vibrate in the Z-axis direction in an unwanted manner due to the vibration in the Z-axis in-phase mode, and noise occurs due to the unwanted vibration.

As described above, in the gyro element of Document 1, there is a problem that it is difficult to suppress the unwanted vibration of the detection arms, and thus the detection accuracy degrades.

### SUMMARY

An advantage of some aspects of the invention is to provide an angular velocity detection element, an angular velocity detection device, an electronic apparatus, and a moving object each capable of reducing the unwanted vibration to reduce the degradation of the detection accuracy.

The invention can be implemented as the following forms or application examples.

### Application Example 1

An angular velocity detection element according to this application example includes a base section, at least two drive arms connected to the base section, and a detection section adapted to detect an angular velocity applied in a state in which the two drive arms are flexurally vibrated in a drive vibration mode, and the two drive arms flexurally vibrate in phase in an in-plane direction of the base section, and flexurally vibrate in reverse phase in a thickness direction of the base section in the drive vibration mode.

According to this application example, the angular velocity detection element capable of suppressing the out-of-plane vibration (unwanted vibration), and capable of reducing the degradation of the detection accuracy is achieved.

### Application Example 2

In the angular velocity detection element according to the application example, it is preferable that the two drive arms are tilted so that a distance between the two drive arms increases toward a tip side of the drive arms.

According to this application example, the contact between the drive arms can be reduced.

### Application Example 3

In the angular velocity detection element according to the application example, it is preferable that there is included a first vibrating system and a second vibrating system each having the detection section and the two drive arms, and in the drive vibration mode, the two drive arms of the first vibrating system and the two drive arms of the second vibrating system flexurally vibrate in reverse phase in the in-plane direction.

According to this application example, it is possible to cancel out the vibrations in the in-plane direction to thereby reduce the vibration leakage.

### Application Example 4

In the angular velocity detection element according to the application example, it is preferable that the drive arm of the first vibrating system located on the second vibrating system side, and the drive arm of the second vibrating system located on the first vibrating system side flexurally vibrate in reverse phase in the thickness direction of the base section in the drive vibration mode.

According to this application example, the contact between the drive arms can be reduced.

### Application Example 5

In the angular velocity detection element according to the application example, it is preferable that the detection section is disposed between the base section and the two drive arms.

According to this application example, the Coriolis force applied to the drive arms can efficiently be transmitted to the detection section.

### Application Example 6

In the angular velocity detection element according to the application example, it is preferable that the detection section is disposed on an opposite side to the drive arms with respect to the base section.

According to this application example, it becomes difficult for the vibrations of the drive arms to be transmitted to the detection section, and thus the detection accuracy of the angular velocity is further improved.

### Application Example 7

An angular velocity detection device according to this application example includes the angular velocity detection element according to any one of the application examples described above, and a package adapted to house the angular velocity detection element.

According to this application example, the angular velocity detection device high in reliability can be obtained.

### Application Example 8

An electronic apparatus according to this application example includes the angular velocity detection element according to any one of the application examples described above.

According to this application example, the electronic apparatus high in reliability can be obtained.

### Application Example 9

A moving object according to this application example includes the angular velocity detection element according to any one of the application examples described above.

According to this application example, the moving object high in reliability can be obtained.

### BRIEF DESCRIPTION OF THE DRAWINGS

The invention will be described with reference to the accompanying drawings, wherein like numbers reference like elements.

FIG. 1 is a plan view showing a gyro element (an angular velocity detection element) according to a first embodiment of the invention.

FIG. 2A is a cross-sectional view along the line A-A in FIG. 1, and FIG. 2B is a cross-sectional view along the line B-B in FIG. 1.

FIG. 3 is a diagram showing a drive vibration mode of the gyro element shown in FIG. 1.

FIGS. 4A through 4C are cross-sectional views for describing the mask displacement caused when manufacturing the gyro element shown in FIG. 1.

FIG. 5A is a schematic diagram showing a drive vibration mode, and FIG. 5B is a schematic diagram showing a detection vibration mode.

FIGS. 6A through 6C are cross-sectional views each showing a modified example of cross-sectional shapes of drive arms.

FIG. 7 is a plan view showing a gyro element (an angular velocity detection element) according to a second embodiment of the invention.

FIG. 8 is a plan view showing a gyro element (an angular velocity detection element) according to a third embodiment of the invention.

FIG. 9A is a cross-sectional view along the line C-C in FIG. 8, and FIG. 9B is a cross-sectional view along the line D-D in FIG. 8.

FIG. 10 is a diagram showing the drive vibration mode of the gyro element shown in FIG. 8.

FIG. 11A is a schematic diagram showing the drive vibration mode, and FIG. 11B is a schematic diagram showing the detection vibration mode.

FIG. 12 is a cross-sectional view showing a gyro element (an angular velocity detection element) according to a fourth embodiment of the invention.

FIG. 13 is a diagram showing the drive vibration mode of the gyro element shown in FIG. 12.

FIG. 14 is a plan view showing a gyro element (an angular velocity detection element) according to a fifth embodiment of the invention.

FIG. 15A is a cross-sectional view along the line E-E in FIG. 14, and FIG. 15B is a cross-sectional view along the line F-F in FIG. 14.

FIG. 16A is a schematic diagram showing the drive vibration mode, and FIG. 16B is a schematic diagram showing the detection vibration mode.

FIG. 17 is a plan view showing a gyro element (an angular velocity detection element) according to a sixth embodiment of the invention.

FIG. 18A is a cross-sectional view along the line G-G in FIG. 17, and FIG. 18B is a cross-sectional view along the line H-H in FIG. 17.

FIG. 19 is a diagram showing the drive vibration mode of the gyro element shown in FIG. 17.

FIG. 20A is a schematic diagram showing the drive vibration mode, and FIG. 20B is a schematic diagram showing the detection vibration mode.

FIGS. 21A and 21B are diagrams showing an angular velocity detection device according to a preferred embodiment of the invention, wherein FIG. 21A is a plan view, and FIG. 21B is a cross-sectional view along the line I-I in FIG. 21A.

FIG. 22 is a cross-sectional view showing a gyro sensor according to a preferred embodiment of the invention.

FIG. 23 is a perspective view showing a configuration of a mobile type (or laptop type) personal computer as the electronic apparatus according to the invention.

FIG. 24 is a perspective view showing a configuration of a cellular phone (including a smartphone, PHS and so on) as the electronic apparatus according to the invention.

FIG. 25 is a perspective view showing a configuration of a digital still camera as the electronic apparatus according to the invention.

FIG. 26 is a perspective view showing a configuration of a vehicle as the moving object according to the invention.

### DESCRIPTION OF EXEMPLARY EMBODIMENTS

Hereinafter, an angular velocity detection element, an angular velocity detection device, an electronic apparatus, and a moving object according to the invention will be described in detail based on some embodiments shown in the accompanying drawings.

### 1. Angular Velocity Detection Element

### First Embodiment

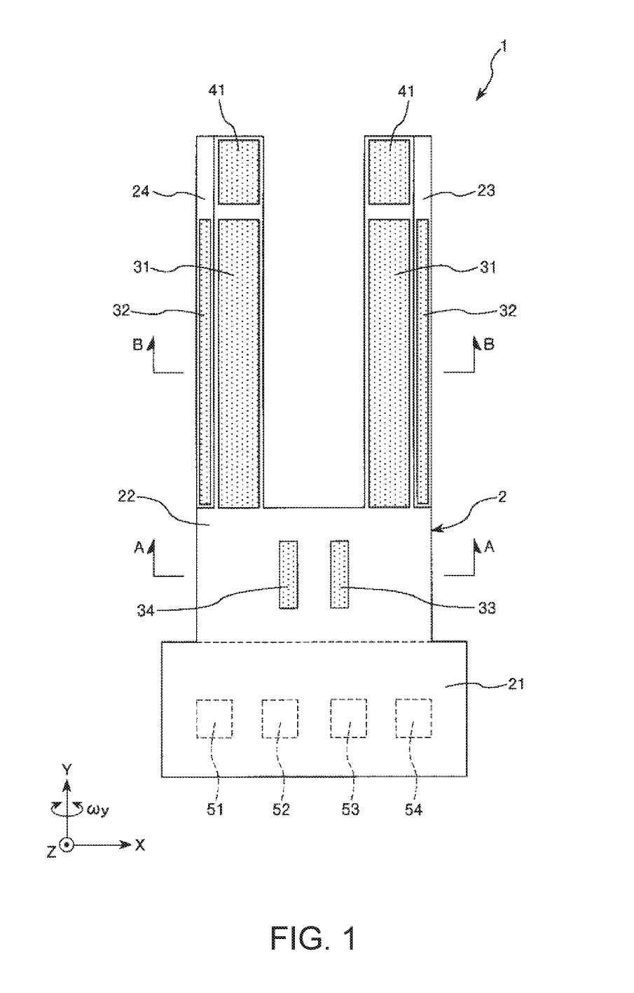

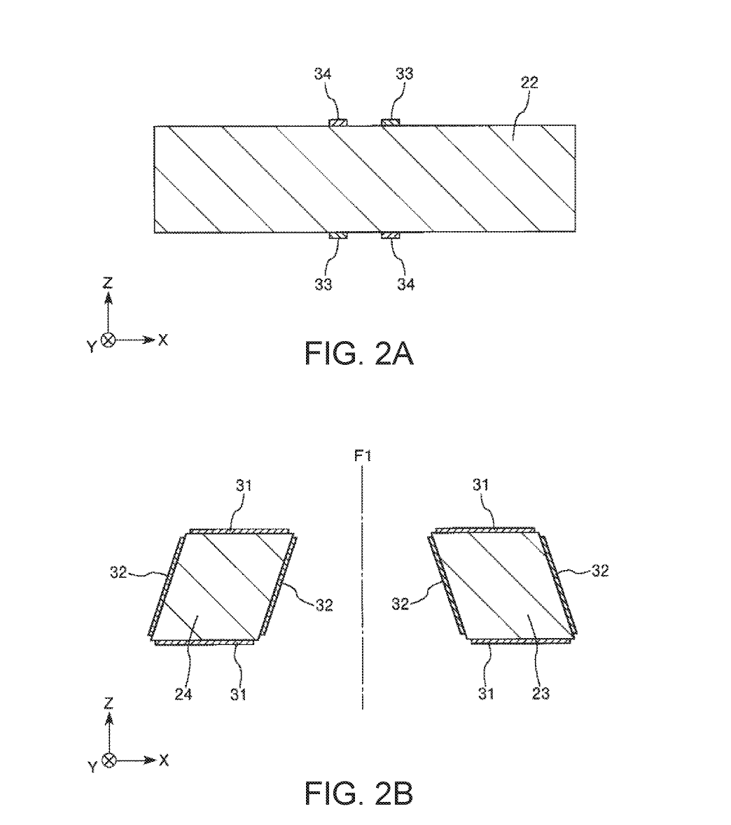

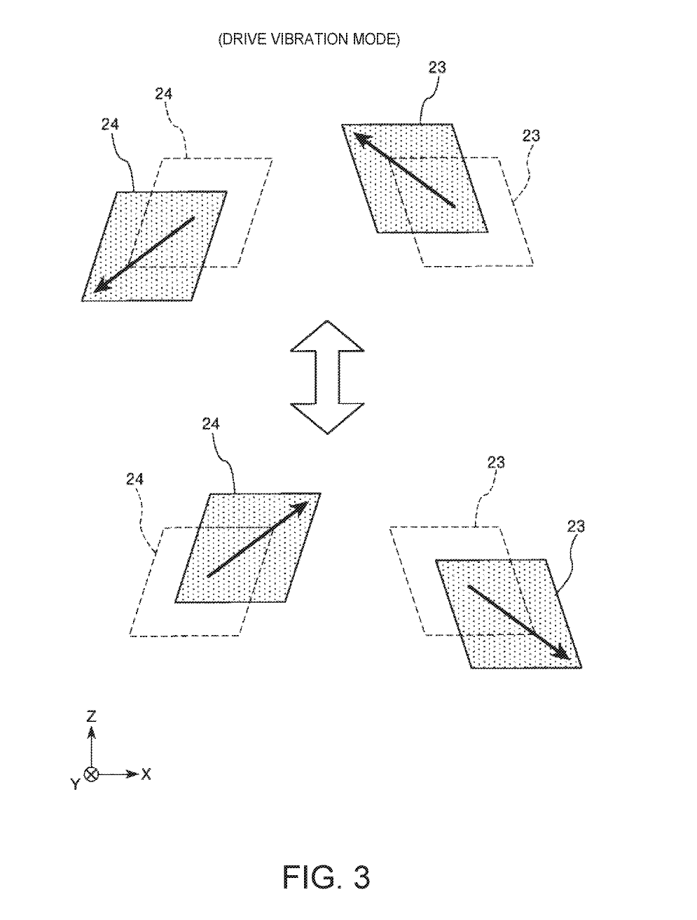

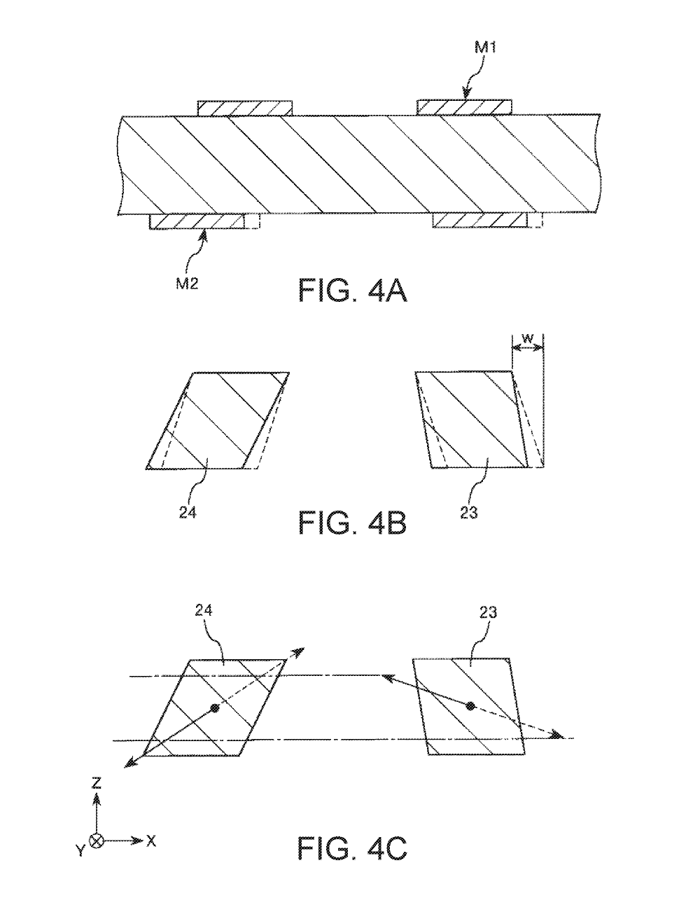

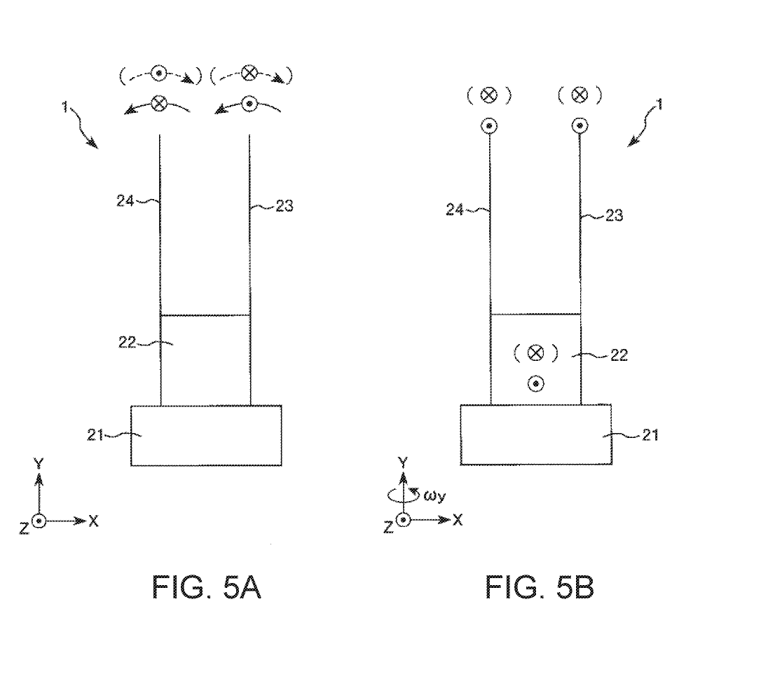

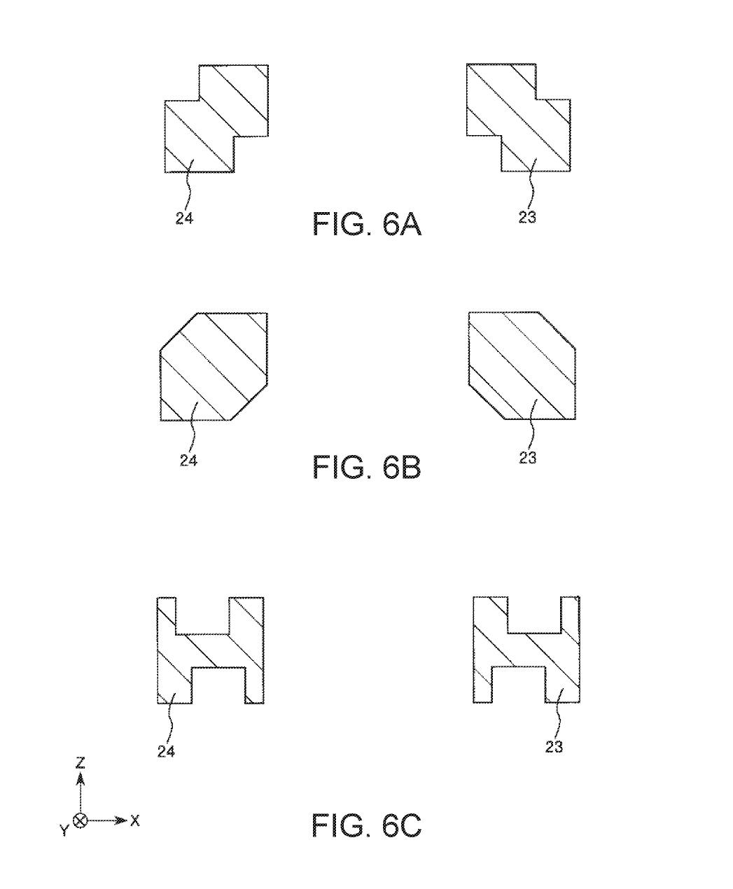

FIG. 1 is a plan view showing a gyro element (an angular velocity detection element) according to a first embodiment of the invention. FIG. 2A is a cross-sectional view along the line A-A in FIG. 1, and FIG. 2B is a cross-sectional view along the line B-B in FIG. 1. FIG. 3 is a diagram showing the drive vibration mode of the gyro element shown in FIG. 1. FIGS. 4A through 4C are cross-sectional views for describing the mask displacement caused when manufacturing the gyro element shown in FIG. 1. FIG. 5A is a schematic diagram showing the drive vibration mode, and FIG. 5B is a schematic diagram showing the detection vibration mode. FIGS. 6A through 6C are cross-sectional views each showing a modified example of cross-sectional shapes of drive arms. It should be noted that the three axes perpendicular to each other are hereinafter defined as an “X axis,” a “Y axis,” and a “Z axis,” respectively as shown in FIG. 1. Further, the +Z-axis side is also referred to as an “upper side” and the −Z-axis side is also referred to as a “lower side” for the sake of convenience of explanation. Further, in each of FIGS. 3, 4A through 4C, 5A, and 5B, electrodes and mass adjustment films are omitted from the graphical description for the sake of convenience of explanation.

The gyro element (the angular velocity detection element) 1 shown in FIG. 1 is a gyro element capable of detecting the angular velocity ωy around the Y axis. Such a gyro element 1 has a piezoelectric substrate 2, a variety of electrodes 31, 32, 33, and 34, a variety of terminals 51, 52, 53, and 54, and mass adjustment films 41 formed on the piezoelectric substrate 2.

Although a configuration of the gyro element 1 will hereinafter be described in detail, a vibration mode in the state in which an angular velocity ωy is not applied is also referred to as a “drive vibration mode,” and a new vibration mode excited by the angular velocity ωy applied during the period in which the gyro element 1 is driven in the drive vibration mode is also referred to as a “detection vibration mode.”

A constituent material of the piezoelectric substrate 2 is not particularly limited, but there can be used a variety of types of piezoelectric material such as quartz crystal, lithium niobate (LiNbO₃), lithium tantalate (LiTaO₃), lead zirconium titanate (PZT), lithium tetraborate (Li₂B₄O₇), or langasite crystal (La₃Ga₅SiO₁₄). It should be noted that among these materials, the quartz crystal is preferably used as the constituent material of the piezoelectric substrate 2. By using the quartz crystal, the gyro element 1 having superior frequency-temperature characteristics compared to other materials can be obtained. It should be noted that the case in which the piezoelectric substrate 2 is constituted by quartz crystal will hereinafter be described. Further, the thickness of the piezoelectric substrate 2 is not particularly limited, and can be set to a value in a range of, for example, 50 μm through 250 μm.

As shown in FIG. 1, the piezoelectric substrate 2 has a plate-like shape having a spread in the X-Y plane defined by the X axis (an electric axis) and the Y axis (a mechanical axis) as the crystal axes of the quartz crystal, and a thickness in the Z-axis (an optical axis) direction. In other words, the piezoelectric substrate 2 is formed of a Z-cut quartz crystal plate. It should be noted that although the Z axis coincides with the thickness direction of the piezoelectric substrate 2 in the present embodiment, the invention is not limited to this configuration, but it is possible to slightly (e.g., within roughly ±15°) tilt the Z axis with respect to the thickness direction of the piezoelectric substrate 2 from the viewpoint of reducing the frequency-temperature variation in the vicinity of the room temperature.

Such a piezoelectric substrate 2 has a base section 21, a detection section 22 connected to the +Y-axis side of the base section 2, and a pair of drive arms 23, 24 extending from an end portion on the +Y-axis side of the detection section 22 toward the +Y-axis side.

The base section 21 supports the detection section 22 and the drive arms 23, 24. Further, the base section 21 has a plate-like shape spreading in the X-Y plane, and having a thickness in the Z-axis direction. Further, in the base section 21, the gyro element 1 is fixed to an object (e.g., a base 81 of a package 8 described later). Further, on the lower surface of the base section 21, there are disposed a drive signal terminal 51, a drive ground terminal 52, a detection signal terminal 53, and a detection ground terminal 54 arranged in the X-axis direction.

The detection section 22 has a plate-like shape spreading in the X-Y plane, and having a thickness in the Z-axis direction. Further, the width (the length in the X-axis direction) of the detection section 22 is arranged to be narrower than the width (the length in the X-axis direction) of the base section 21. It should be noted that the width of the detection section 22 is not particularly limited, but can also be equal to the width of the base section 21, or larger than the width of the base section 21. Further, although in the description of the present embodiment, the detection section 22 and the base section 21 are separated from each other, in other words, it can also be said that “the base section 21 and the detection section 22 are collectively referred to as the base section 21, and a tip portion of the base section 21 forms the detection section 22.”

As shown in FIG. 2A, on each of an upper surface and a lower surface of such a detection section 22, there are disposed a detection signal electrode 33 and a detection ground electrode 34 arranged in the X-axis direction. On the upper surface, the detection ground electrode 34 is located on the −X-axis side of the detection signal electrode 33, and on the lower surface, the detection ground electrode 34 is located on the +X-axis side of the detection signal electrode 33. Further, the detection signal electrodes 33 are connected to the detection signal terminal 53 via wiring not shown, and the detection ground electrodes 34 are connected to the detection ground terminal 54 via wiring not shown. It should be noted that it is sufficient for the detection signal electrode 33 and the detection ground electrode 34 to be disposed at least one of the upper surface and the lower surface of the detection section 22.

Further, the pair of drive arms 23, 24 are disposed side by side in the X-axis direction, and extend from the detection section 22 toward the +Y-axis side. Further, as shown in FIG. 2B, the cross-sectional shapes of these drive arms 23, 24 are each formed to be a roughly parallelogram shape. Further, the parallelograms as the cross-sectional shapes of the drive arms 23, 24 are tilted toward the directions opposite to each other, and are symmetrical to a plane F1 as the Y-Z plane.

Further, in each of the tip portions of the drive arms 23, 24, there is disposed the mass adjustment film 41. By removing a part of the mass adjustment film 41 to vary the mass of each of the drive arms 23, 24 when needed, the frequency of each of the drive arms 23, 24 can be adjusted. The mass adjustment films 41 are each formed of a metal film, and can be formed integrally with, for example, the drive signal electrode 31 or the drive ground electrode 32 (it should be noted that in FIG. 1, the mass adjustment films 41 are illustrated as separated ones for the sake of convenience).

Further, the drive arms 23, 24 are each provided with the drive signal electrodes 31 and the drive ground electrodes 32. The drive signal electrodes 31 are disposed on both of the principal surfaces (the upper surface and the lower surface) of each of the drive arms 23, 24, and the drive ground electrodes 32 are disposed on both of the side surfaces of each of the drive arms 23, 24. Further, the drive signal electrodes 31 are connected to the drive signal terminal 51 via wiring not shown, and the drive ground electrodes 32 are connected to the drive ground terminal 52 via wiring not shown. Therefore, by applying an alternating voltage with a predetermined frequency between the drive signal electrodes 31 and the drive ground electrodes 32 via the drive signal terminal 51 and the drive ground terminal 52, it is possible to flexurally vibrate the drive arms 23, 24 in an X-axis in-phase mode.

Here, since the cross-sectional shapes of the drive arms 23, 24 are each a parallelogram as described above, the balance of the vibration in the X-axis direction between the drive arms 23, 24 is lost, and thus, the drive arms 23, 24 vibrate in the X-axis direction including the vibration component in the Z-axis direction in the drive vibration mode. Further, since the tilt directions of the parallelograms as the cross-sectional shapes of the drive arms 23, 24 are opposite to each other, the vibration components in the Z-axis direction included in the drive arms 23, 24 are in the respective directions opposite to each other.

In other words, in the drive vibration mode, the drive arms 23, 24 vibrate in the X-axis in-phase mode and in the Z-axis inverse-phase mode (vibrate in phase in the in-plane direction of the base section 21, and vibrate in reverse phase in the thickness direction of the base section 21) as shown in FIG. 3. By the drive arms 23, 24 vibrating in the Z-axis direction in reverse phase in the drive vibration mode as described above, it is possible to cancel (cancel out or absorb) the vibrations in the Z-axis direction, and thus, it is possible to reduce (preferably prevent) the vibration in the Z-axis direction of the detection section 22 in the drive vibration mode. Therefore, the gyro element 1 reduced in noise and high in detection accuracy is achieved.

Further, according to the gyro element 1, even in the case in which the masks M1, M2 are shifted from each other in the X-axis direction in the manufacturing process as shown in FIG. 4A, only the tilts of the parallelograms of the cross-sectional shapes of the drive arms 23, 24 are made slightly different from each other as shown in FIG. 4B, but there is maintained the relationship that the drive arms 23, 24 vibrate in the Z-axis inverse-phase mode in the drive vibration mode. Therefore, according to the gyro element 1, even if the mask displacement occurs, the advantage described above can be exerted.

Here, it is preferable to set, for example, the displacement width win the X-axis direction between the lower surface and the upper surface of the drive arms 23, 24 to be equal to or more than 10 times as large as the maximum possible mask displacement amount in the normal operation so that the cross-sectional shapes of the drive arms 23, 24 are kept in the parallelograms having the tilts opposite to each other even if the mask displacement occurs. Specifically, in the case of a mechanism in which the maximum mask displacement of 0.1 μm might occur, it is sufficient to design the displacement width w to be equal to or larger than 1 μm. Thus, it is possible to make the drive arms 23, 24 vibrate in the Z-axis inverse-phase mode in the drive vibration mode irrespective of the presence or absence of the mask displacement.

It should be noted that if the tilts of the parallelograms of the cross-sectional shapes of the drive arms 23, 24 are made different from each other as shown in FIG. 4B due to the mask displacement, the amplitude in the Z-axis direction is made different between the drive arms 23, 24 as shown in FIG. 4C in some cases. In such a case, there is a possibility that the vibration component in the Z-axis direction is not sufficiently canceled, and thus, the advantage described above degrades in the drive vibration mode. Therefore, it is preferable to roughly uniform the amplitude in the Z-axis direction between the drive arms 23, 24.

As a method of uniforming the amplitude, there can be cited, for example, a method of adjusting the mass of at least one of the drive arms 23, 24. The case in which the amplitude in the Z-axis direction of the drive arm 24 is larger than the amplitude in the Z-axis direction of the drive arm 23 as shown in FIG. 4C will hereinafter be described as a representative. As a first method, there is a method of removing a part of the mass adjustment film 41 disposed in the tip portion of the drive arm 24 using laser irradiation or the like to reduce the mass of the drive arm 24 to thereby decrease the amplitude in the Z-axis direction of the drive arm 24. As a second method, there is a method of disposing a weight on the mass adjustment film 41 disposed in the tip portion of the drive arm 23 to increase the mass of the drive arm 23 to thereby increase the amplitude in the Z-axis direction of the drive arm 23. According to such methods, it is possible to uniform the amplitude in the Z-axis direction between the drive arms 23, 24 with relative ease.

Hereinabove, the configuration of the gyro element 1 is described in detail.

Then, drive of the gyro element 1 will be described. Firstly, as shown in FIG. 5A, the drive arms 23, 24 are made to vibrate in the drive vibration mode. In this state, since the vibrations in the Z-axis direction of the drive arms 23, 24 are canceled as described above, the detection section 22 hardly vibrates in the Z-axis direction. Therefore, a charge is hardly generated between the detection signal electrode 33 and the detection ground electrode 34, and the detection signal SS taken out between the detection signal electrode 33 and the detection ground electrode 34 is approximately 0 (zero).

When the angular velocity ωy around the Y axis is applied to the gyro element 1 in the state of vibrating in the drive vibration mode, the Coriolis force acts to newly excite the vibration in the detection vibration mode, and the drive arms 23, 24 vibrate in the Z-axis in-phase mode as shown in FIG. 5B. When such a vibration in the detection vibration mode is excited, the detection section 22 vibrates in the Z-axis direction due to the vibration thus excited, and thus, a charge is generated between the detection signal electrode 33 and the detection ground electrode 34 due to the vibration. Then, the charge having been generated between the detection signal electrode 33 and the detection ground electrode 34 is taken out as the detection signal SS, and then the angular velocity ωy is obtained based on the magnitude of the detection signal.

According to such a gyro element 1, since the vibrations in the Z-axis direction of the drive arms 23, 24 in the drive vibration mode can be canceled, an unwanted vibration of the detection section 22 in the drive vibration mode can be suppressed. Therefore, the gyro element 1 reduced in noise and high in detection accuracy is achieved. Further, even in the case in which the mask displacement occurs in the manufacturing process, since it is possible to make the drive arms 23, 24 vibrate in the Z-axis inverse-phase mode in the drive vibration mode as described above, the advantage described above can more surely be exerted.

In particular, since in the present embodiment, the detection section 22 is located between the base section 21 and the drive arms 23, 24, it is possible to more efficiently transmits the vibrations in the Z-axis direction of the drive arms 23, 24 to the detection section 22. Therefore, the detection accuracy of the angular velocity is further improved.

The gyro element 1 according to the first embodiment is hereinabove described. It should be noted that although in the present embodiment, the parallelograms are adopted as the cross-sectional shapes of the drive arms 23, 24 in order to vibrate the drive arms 23, 24 in the X-axis in-phase mode and in the Z-axis inverse-phase mode in the drive vibration mode, the cross-sectional shapes of the drive arms 23, 24 are not limited thereto providing the vibrations described above can be performed, but can also be, for example, the cross-sectional shapes shown in each of FIGS. 6A through 6C.

Further, although in the gyro element 1 according to the present embodiment, a hammerhead (a wide weight section) is not provided to the tip portion of each of the drive arms 23, 24, it is also possible to provide the hammerhead to each of the tip portions of the drive arms 23, 24. Thus, the mass effect of the tips of the drive arms 23, 24 increases, and assuming that the frequency in the drive vibration mode is the same, the length of the drive arms 23, 24 can be made shorter compared to the case in which the hammerheads are not provided. Further, assuming that the length of the drive arms 23, 24 is the same, the drive frequency can be made lower.

### Second Embodiment

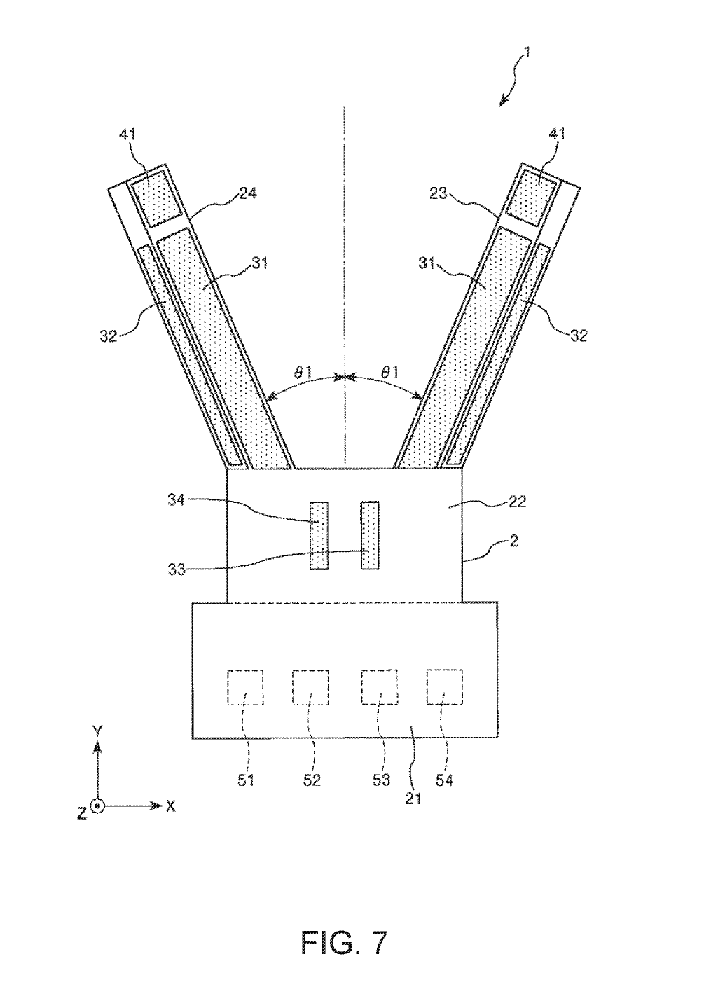

FIG. 7 is a plan view showing a gyro element (an angular velocity detection element) according to a second embodiment of the invention.

The second embodiment will hereinafter be described focusing mainly on the differences from the embodiment described above, and the explanation of substantially the same matters will be omitted.

The second embodiment is substantially the same as the first embodiment described above except the point that the extending direction of the pair of drive arms is different. It should be noted that in FIG. 7, the constituents substantially identical to those of the embodiment described above are denoted by the same reference symbols.

As shown in FIG. 7, in the gyro element 1 according to the present embodiment, the drive arms 23, 24 are disposed extending in directions tilted with respect to the Y axis so that the distance (the distance in the X-axis direction) from each other gradually increases toward the tip side in a planar view viewed from the Z-axis direction. It should be noted that since the piezoelectric substrate 2 is formed of quartz crystal (hexagonal crystal), the tilt angle θ1 of each of the drive arms 23, 24 with respect to the Y axis is preferably set to around 30°. Thus, it is possible to make the extending direction of the drive arms 23, 24 roughly coincide with the polarization direction of the quartz crystal, and thus, the gyro element 1 having superior vibration characteristics is achieved. Further, it is also possible to reduce the contact between the drive arms 23, 24 during the vibration, and it is also possible to reduce a damage of the gyro element 1.

According also to such a second embodiment as described above, substantially the same advantages as in the first embodiment described above can be obtained.

### Third Embodiment

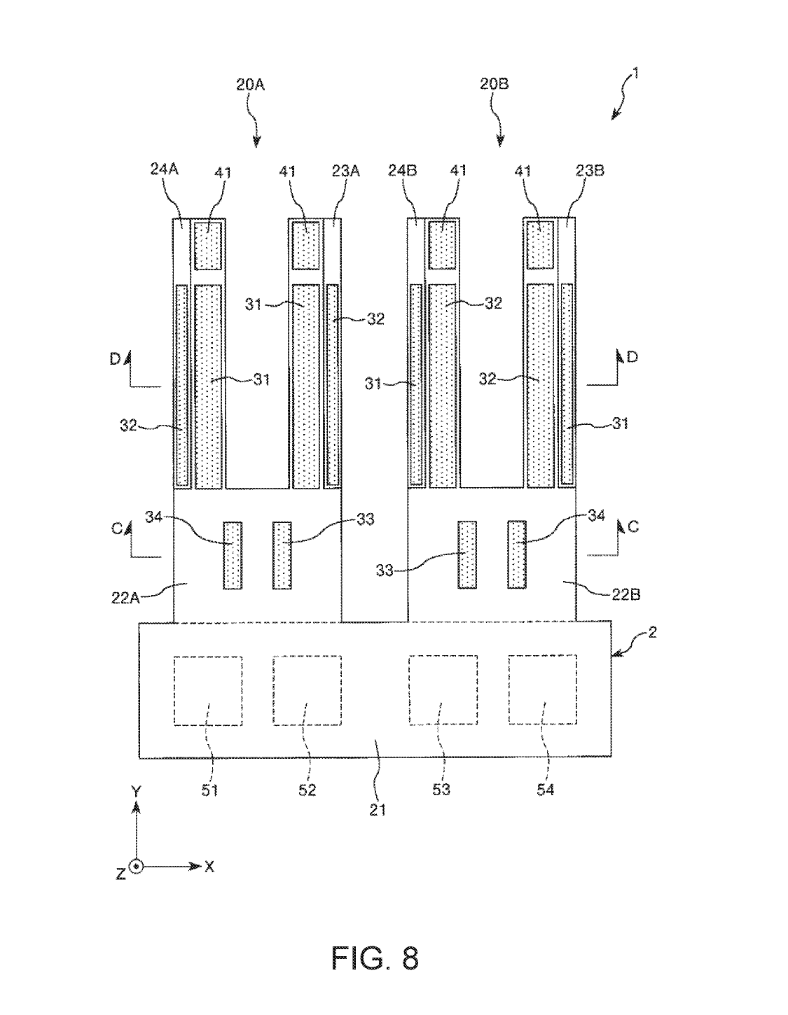

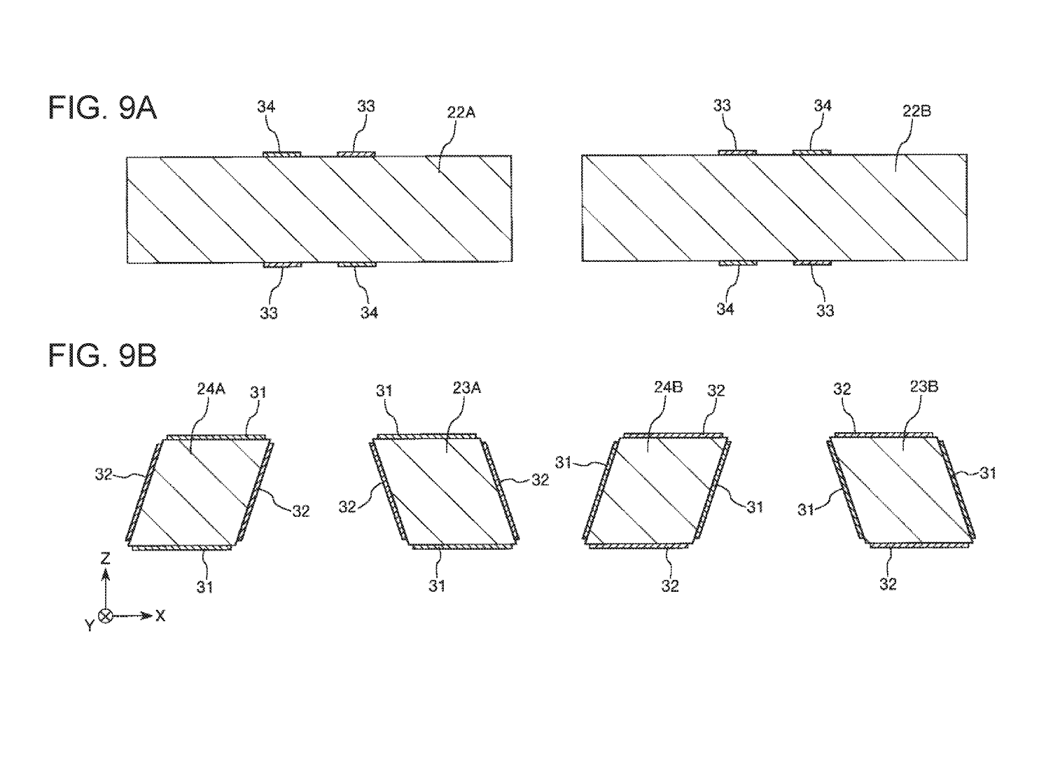

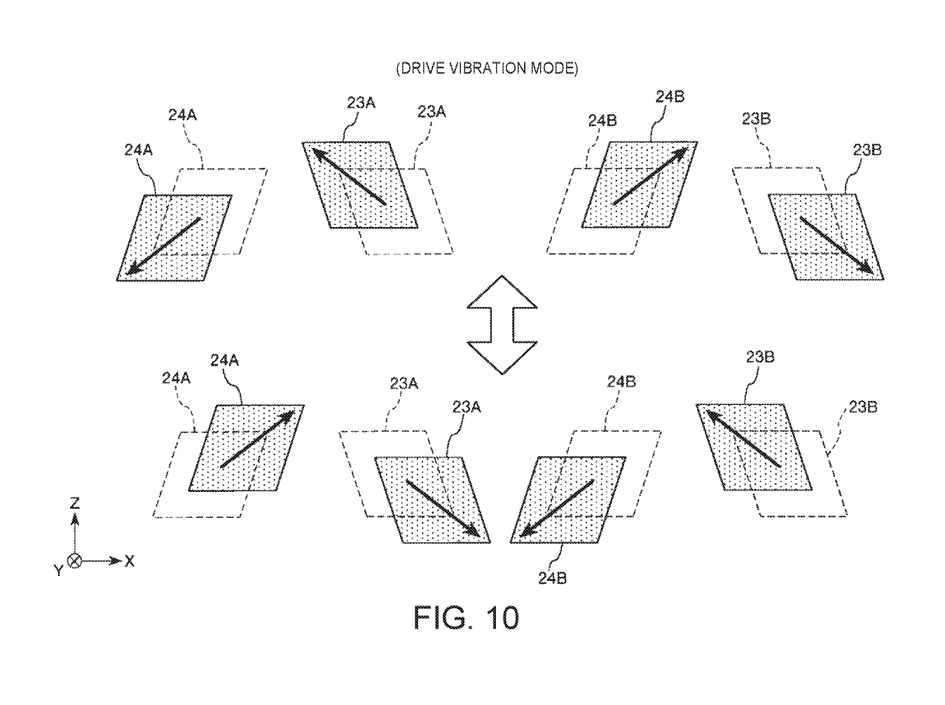

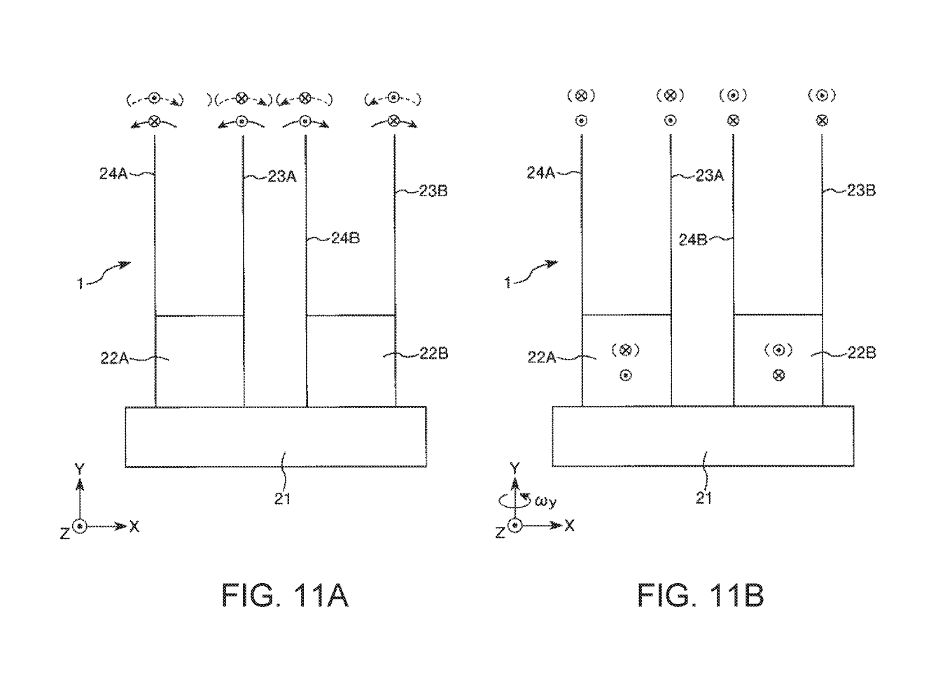

FIG. 8 is a plan view showing a gyro element (an angular velocity detection element) according to a third embodiment of the invention. FIG. 9A is a cross-sectional view along the line C-C in FIG. 8, and FIG. 9B is a cross-sectional view along the line D-D in FIG. 8. FIG. 10 is a diagram showing the drive vibration mode of the gyro element shown in FIG. 8. FIG. 11A is a schematic diagram showing the drive vibration mode, and FIG. 11B is a schematic diagram showing the detection vibration mode.

The third embodiment will hereinafter be described mainly focusing on the differences from the embodiments described above, and the explanation of substantially the same matters will be omitted.

The third embodiment is substantially the same as the first embodiment described above except the point that there are disposed two sets of vibrating systems each formed of the detection section and the drive arms.

As shown in FIG. 8, the piezoelectric substrate 2 of the gyro element 1 according to the present embodiment includes the base section 21, a pair of detection sections 22A, 22B connected to the +Y-axis side of the base section 21, and disposed with a distance in the X-axis direction so as to form a gap (a space) in between, a pair of drive arms 23A, 24A extending from the detection section 22A toward the +Y-axis side, and a pair of drive arms 23B, 24B extending from the detection section 22B toward the +Y-axis side. In such a configuration, the detection section 22A and the drive arms 23A, 24A constitute the first vibrating system 20A, and the detection section 22B and the drive arms 23B, 24B constitute the second vibrating system 20B.

As shown in FIG. 9A, on each of an upper surface and a lower surface of the detection section 22A, there are disposed the detection signal electrode 33 and the detection ground electrode 34 arranged in the X-axis direction. On the upper surface of the detection section 22A, the detection ground electrode 34 is located on the −X-axis side of the detection signal electrode 33, and on the lower surface, the detection ground electrode 34 is located on the +X-axis side of the detection signal electrode 33. Similarly, on each of an upper surface and a lower surface of the detection section 22B, there are also disposed the detection signal electrode 33 and the detection ground electrode 34 arranged in the X-axis direction. On the upper surface of the detection section 22B, the detection ground electrode 34 is located on the +X-axis side of the detection signal electrode 33, and on the lower surface, the detection ground electrode 34 is located on the −X-axis side of the detection signal electrode 33. These detection signal electrodes 33 are connected to the detection signal terminal 53 via wiring not shown, and the detection ground electrodes 34 are connected to the detection ground terminal 54 via wiring not shown.

Further, as shown in FIG. 9B, the cross-sectional shapes of the drive arms 23A, 24A, 23B, and 24B are each formed to be a roughly parallelogram shape. Further, the parallelograms as the cross-sectional shapes of the drive arms 23A, 23B are the same in tilt as each other, the parallelograms as the cross-sectional shapes of the drive arms 24A, 24B are the same in tilt as each other, and are opposite in tilt to those of the drive arms 23A, 23B.

Further, the drive arms 23A, 24A, 23B, and 24B are each provided with the drive signal electrodes 31 and the drive ground electrodes 32. The drive signal electrodes 31 are disposed on both principal surfaces of each of the drive arms 23A, 24A, and both side surfaces of each of the drive arms 23B, 24B, and the drive ground electrodes 32 are disposed on both side surfaces of each of the drive arms 23A, 24A, and both principal surfaces of each of the drive arms 23B, 24B. These drive signal electrodes 31 are connected to the drive signal terminal 51 via wiring not shown, and the drive ground electrodes 32 are connected to the drive ground terminal 52 via wiring not shown.

The gyro element 1 having such a configuration vibrates in the drive vibration mode shown in FIG. 10. Specifically, the drive arms 23A, 24A vibrate in the X-axis in-phase mode, and the drive arms 23B, 24B vibrate in the X-axis in-phase mode, and the drive arms 23A, 24A and the drive arms 23B, 24B vibrate in the X-axis inverse-phase mode. Further, coupling to such vibrations in the X-axis direction, the drive arms 23A, 24B vibrate in the Z-axis in-phase mode, and the drive arms 24A, 23B vibrate in the Z-axis in-phase mode, and the drive arms 23A, 24B and the drive arms 24A, 23B vibrate in the Z-axis inverse-phase mode.

In the state in which the gyro element 1 is driven in the drive vibration mode as shown in FIG. 11A, since the vibrations in the X-axis direction of the drive arms 23A, 24A and the drive arms 23B, 24B are canceled, vibration leakage is reduced. Further, in the state in which the gyro element 1 is driven in the drive vibration mode, the vibrations in the Z-axis direction of the drive arms 23A, 24A are canceled, and thus, the detection section 22A hardly vibrates in the Z-axis direction. Similarly, since the vibrations in the Z-axis direction of the drive arms 23B, 24B are canceled, the detection section 22B also hardly vibrates in the Z-axis direction. Therefore, the detection signal SS taken out between the detection signal terminal 53 and the detection ground terminal 54 is approximately 0 (zero).

When the angular velocity ωy around the Y axis is applied to the gyro element 1 in the state of the drive vibration mode, the Coriolis force acts to newly excite the vibration in the detection vibration mode as shown in FIG. 11B. Specifically, the drive arms 23A, 24A vibrate in the Z-axis in-phase mode, and the drive arms 23B, 24B vibrate in the Z-axis in-phase mode, and the drive arms 23A, 24A and the drive arms 23B, 24B vibrate in the Z-axis inverse-phase mode. Further, due to such vibrations of the drive arms 23A, 24A, 23B, and 24B, the detection sections 22A, 22B vibrate in the Z-axis inverse-phase mode. Therefore, the charges with the same phase are generated from the detection sections 22A, 22B, and the detection signal SS obtained by adding these charges to each other is taken out between the detection signal terminal 53 and the detection ground terminal 54. Then, the angular velocity ωy is obtained based on the detection signal SS.

As described above, in the present embodiment, since the detection signal SS can roughly be doubled compared to the first embodiment due to the signals from the detection sections 22A, 22B, the gyro element 1 higher in detection accuracy is achieved. Further, according to the present embodiment, since the vibrations in the X-axis direction and the Z-axis direction of the drive arms 23A, 24A, 23B, and 24B, and the detection sections 22A, 22B can be canceled in the drive vibration mode and the detection vibration mode, the vibration leakage of the gyro element 1 can be reduced, and thus, the detection accuracy is further improved.

According also to such a third embodiment as described above, substantially the same advantages as in the first embodiment described above can be exerted.

### Fourth Embodiment

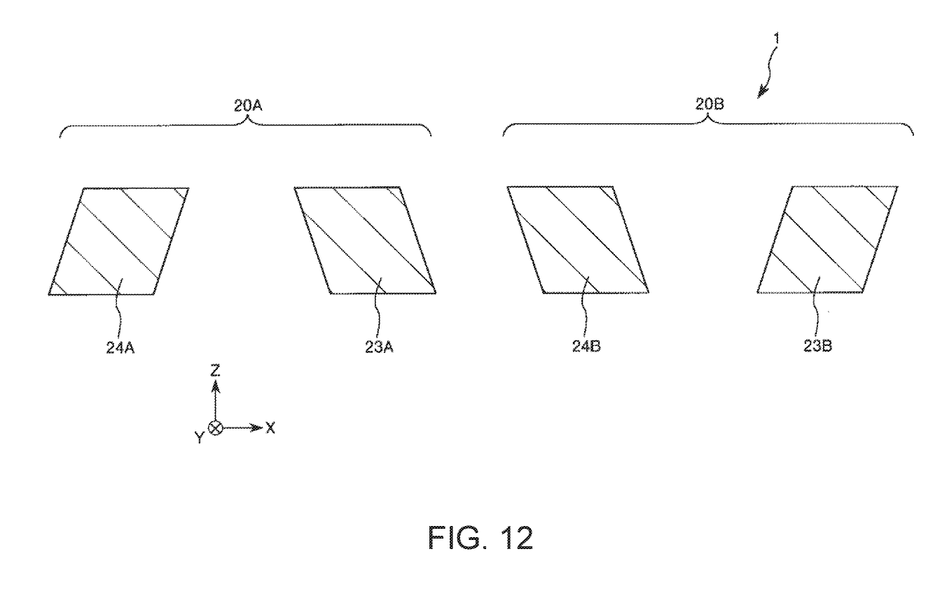

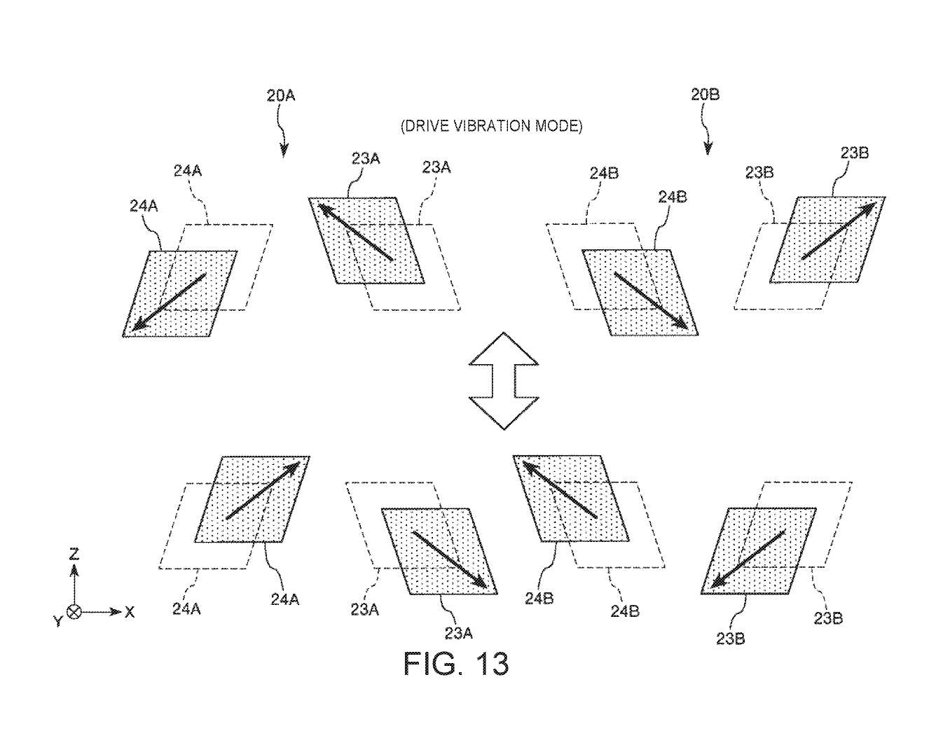

FIG. 12 is a cross-sectional view showing a gyro element (an angular velocity detection element) according to a fourth embodiment of the invention. FIG. 13 is a diagram showing the drive vibration mode of the gyro element shown in FIG. 12.

The fourth embodiment will hereinafter be described mainly focusing on the differences from the embodiments described above, and the explanation regarding substantially the same matters will be omitted.

The fourth embodiment is substantially the same as the third embodiment described above except the point that the cross-sectional shapes of the drive arms are different. It should be noted that in FIGS. 12 and 13, the constituents substantially identical to those of the embodiment described above are denoted by the same reference symbols.

As shown in FIG. 12, in the gyro element 1 according to the present embodiment, the cross-sectional shapes of the drive arms 23B, 24B are vertically flipped with respect to those in the third embodiment. If adopting such a configuration, the gyro element 1 vibrates in the drive vibration mode shown in FIG. 13. Specifically, the drive arms 23A, 24A vibrate in the X-axis in-phase mode, and the drive arms 23B, 24B vibrate in the X-axis in-phase mode, and the drive arms 23A, 24A and the drive arms 23B, 24B vibrate in the X-axis inverse-phase mode. Further, coupling to such vibrations in the X-axis direction, the drive arms 23A, 23B vibrate in the Z-axis in-phase mode, and the drive arms 24A, 24B vibrate in the Z-axis in-phase mode, and the drive arms 23A, 23B and the drive arms 24A, 24B vibrate in the Z-axis inverse-phase mode. According to such vibrations, when the drive arm 23A (the drive arm of the first vibrating system 20A located on the second vibrating system 20B side) and the drive arm 24B (the drive arm of the second vibrating system 20B located on the first vibrating system 20A side) come close to each other, the drive arms can be shifted toward the opposite sides in the Z-axis direction. Therefore, it becomes difficult for the drive arms 23A, 24B to have contact with each other, and thus, the damage of the gyro element 1 can be reduced. Further, since the detection sections 22A, 22B can be made close to each other accordingly, miniaturization of the gyro element 1 can be achieved.

According also to such a fourth embodiment as described above, substantially the same advantages as in the first embodiment described above can be exerted.

### Fifth Embodiment

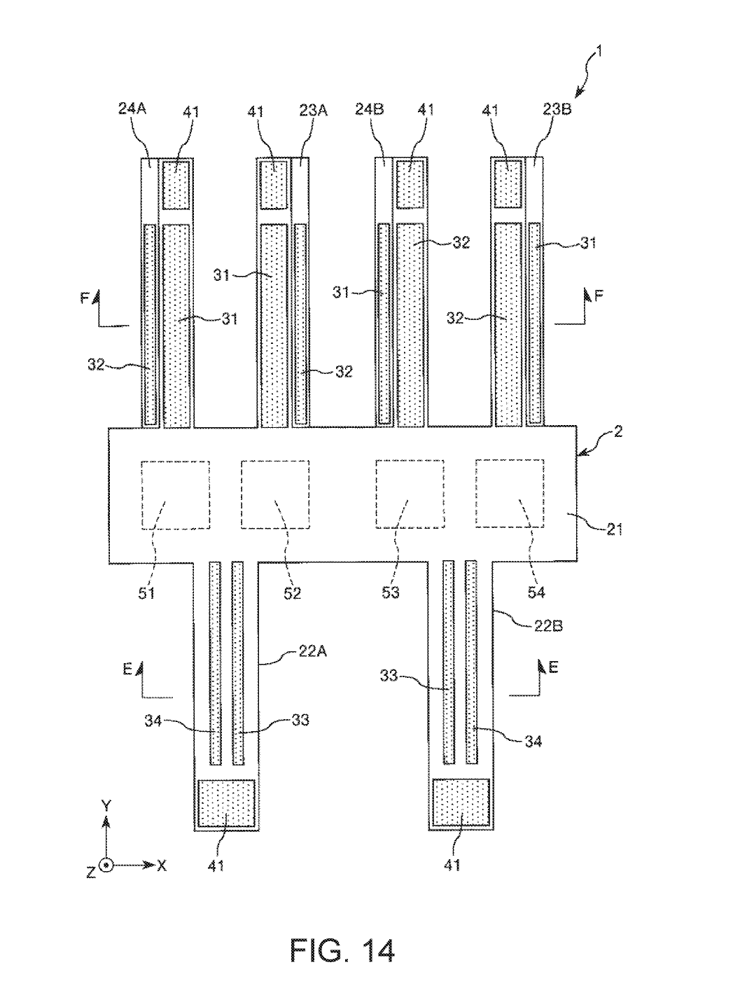

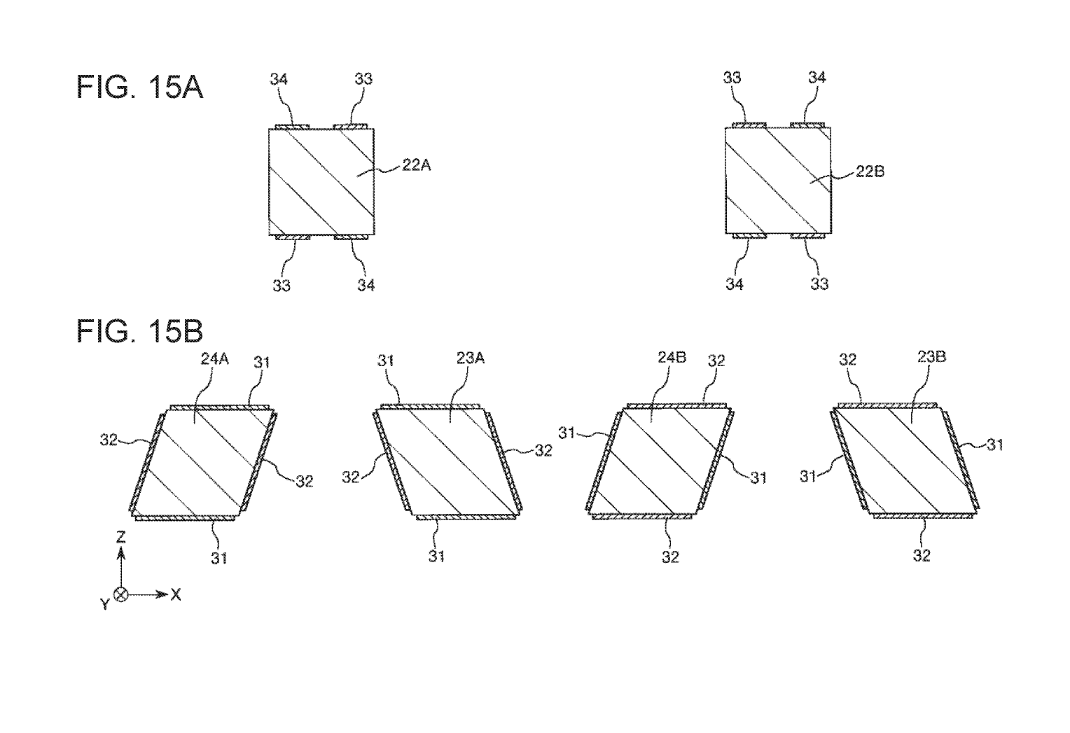

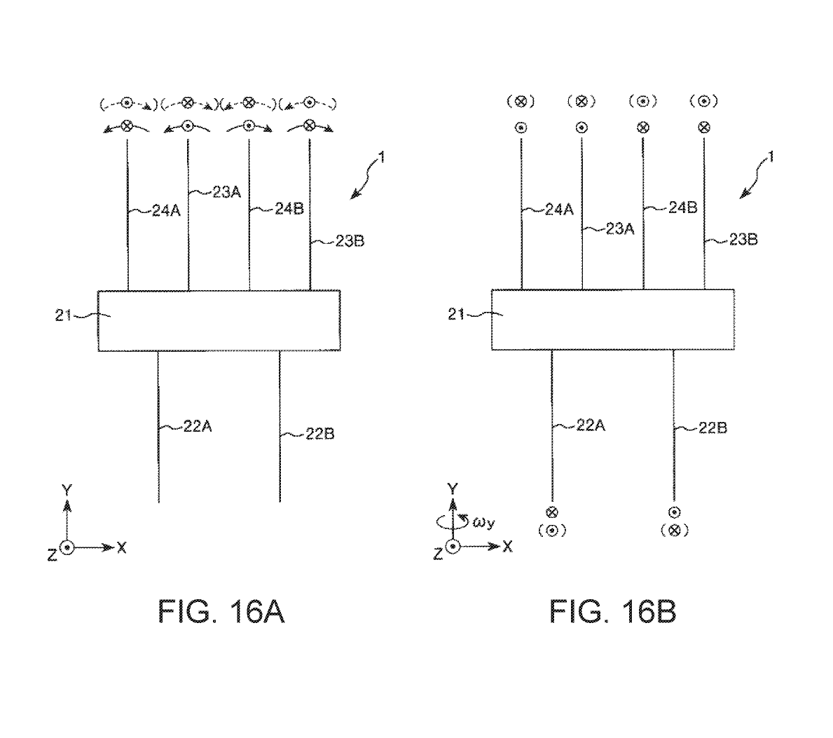

FIG. 14 is a plan view showing a gyro element (an angular velocity detection element) according to a fifth embodiment of the invention. FIG. 15A is a cross-sectional view along the line E-E in FIG. 14, and FIG. 15B is a cross-sectional view along the line F-F in FIG. 14. FIG. 16A is a schematic diagram showing the drive vibration mode, and FIG. 16B is a schematic diagram showing the detection vibration mode.

The fifth embodiment will hereinafter be described mainly focusing on the differences from the embodiments described above, and the explanation of substantially the same matters will be omitted.

The fifth embodiment is substantially the same as the third embodiment described above except the point that the positions of the detection sections are different. It should be noted that in FIGS. 14, 15A, 15B, 16A, and 16B, the constituents substantially identical to those of the embodiment described above are denoted by the same reference symbols.

As shown in FIG. 14, in the gyro element 1 according to the present embodiment, the drive arms 23A, 24A, 23B, and 24B extend from the base section 21 toward the +Y-axis side, and the detection sections 22A, 22B extend from the base section 21 toward the −Y-axis side. In other words, the detection sections 22A, 22B are located on the opposite side to the drive arms 23A, 24A, 23B, and 24B with respect to the base section 21. Thus, the vibrations of the drive arms 23A, 24A, 23B, and 24B become difficult to propagate to the detection sections 22A, 22B, and thus the detection accuracy of the angular velocity ωy is improved.

Further, the detection section 22A is located between the drive arms 23A, 24A, and the detection section 22B is located between the drive arms 23B, 24B. Further, the detection sections 22A, 22B each have an elongated arm-like shape extending in the Y-axis direction.

As shown in FIG. 15A, on each of the upper surface and the lower surface of the detection section 22A, there are disposed the detection signal electrode 33 and the detection ground electrode 34 arranged in the X-axis direction. On the upper surface of the detection section 22A, the detection ground electrode 34 is located on the −X-axis side of the detection signal electrode 33, and on the lower surface, the detection ground electrode 34 is located on the +X-axis side of the detection signal electrode 33.

Similarly, on each of the upper surface and the lower surface of the detection section 22B, there are also disposed the detection signal electrode 33 and the detection ground electrode 34 arranged in the X-axis direction. On the upper surface of the detection section 22B, the detection ground electrode 34 is located on the +X-axis side of the detection signal electrode 33, and on the lower surface, the detection ground electrode 34 is located on the −X-axis side of the detection signal electrode 33. These detection signal electrodes 33 are each connected to the detection signal terminal 53 via wiring not shown, and the detection ground electrodes 34 are each connected to the detection ground terminal 54 via wiring not shown.

Further, as shown in FIG. 15B, the drive arms 23A, 24A, 23B, and 24B are each provided with the drive signal electrodes 31 and the drive ground electrodes 32. The drive signal electrodes 31 are disposed on both principal surfaces of each of the drive arms 23A, 24A, and both side surfaces of each of the drive arms 23B, 24B, and the drive ground electrodes 32 are disposed on both side surfaces of each of the drive arms 23A, 24A, and both principal surfaces of each of the drive arms 23B, 24B. These drive signal electrodes 31 are each connected to the drive signal terminal 51 via wiring not shown, and the drive ground electrodes 32 are each connected to the drive ground terminal 52 via wiring not shown.

Such a gyro element 1 vibrates in the drive vibration mode shown in FIG. 16A. Specifically, the drive arms 23A, 24A vibrate in the X-axis in-phase mode, and the drive arms 23B, 24B vibrate in the X-axis in-phase mode, and the drive arms 23A, 24A and the drive arms 23B, 24B vibrate in the X-axis inverse-phase mode. Further, coupling to such vibrations in the X-axis direction, the drive arms 23A, 24B vibrate in the Z-axis in-phase mode, and the drive arms 24A, 23B vibrate in the Z-axis in-phase mode, and the drive arms 23A, 24B and the drive arms 24A, 23B vibrate in the Z-axis inverse-phase mode.

In the state in which the gyro element 1 is vibrated in the drive vibration mode, the vibrations in the Z-axis direction of the drive arms 23A, 24A, 23B, and 24B are canceled, and thus, the detection sections 22A, 22B both hardly vibrate in the Z-axis direction. Therefore, the detection signal taken out between the detection signal terminal 53 and the detection ground terminal 54 is approximately 0 (zero).

When the angular velocity ωy around the Y axis is applied to the gyro element 1 in the state of the drive vibration mode, the Coriolis force acts to newly excite the vibration in the detection vibration mode shown in FIG. 16B. Specifically, the drive arms 23A, 24A vibrate in the Z-axis in-phase mode, and the drive arms 23B, 24B vibrate in the Z-axis in-phase mode, and the drive arms 23A, 24A and the drive arms 23B, 24B vibrate in the Z-axis inverse-phase mode. Further, due to such vibrations of the drive arms 23A, 24A, 23B, and 24B, the detection sections 22A, 22B vibrate in the Z-axis inverse-phase mode. Therefore, the charges with the same phase are generated from the detection sections 22A, 22B, and the detection signal SS obtained by adding these charges to each other is taken out between the detection signal terminal 53 and the detection ground terminal 54. Then, the angular velocity ωy is obtained based on the detection signal SS.

As described above, in the present embodiment, since the detection signal SS can roughly be doubled compared to the first embodiment due to the charges from the detection sections 22A, 22B, the gyro element 1 higher in detection accuracy is achieved. Further, according to the present embodiment, since the vibrations in the X-axis direction and the Z-axis direction of the drive arms 23A, 24A, 23B, and 24B, and the detection sections 22A, 22B can be canceled in the drive vibration mode and the detection vibration mode, the vibration leakage of the gyro element 1 can be reduced, and thus, the detection accuracy is further improved.

According also to such a fifth embodiment as described above, substantially the same advantages as in the first embodiment described above can be exerted.

### Sixth Embodiment

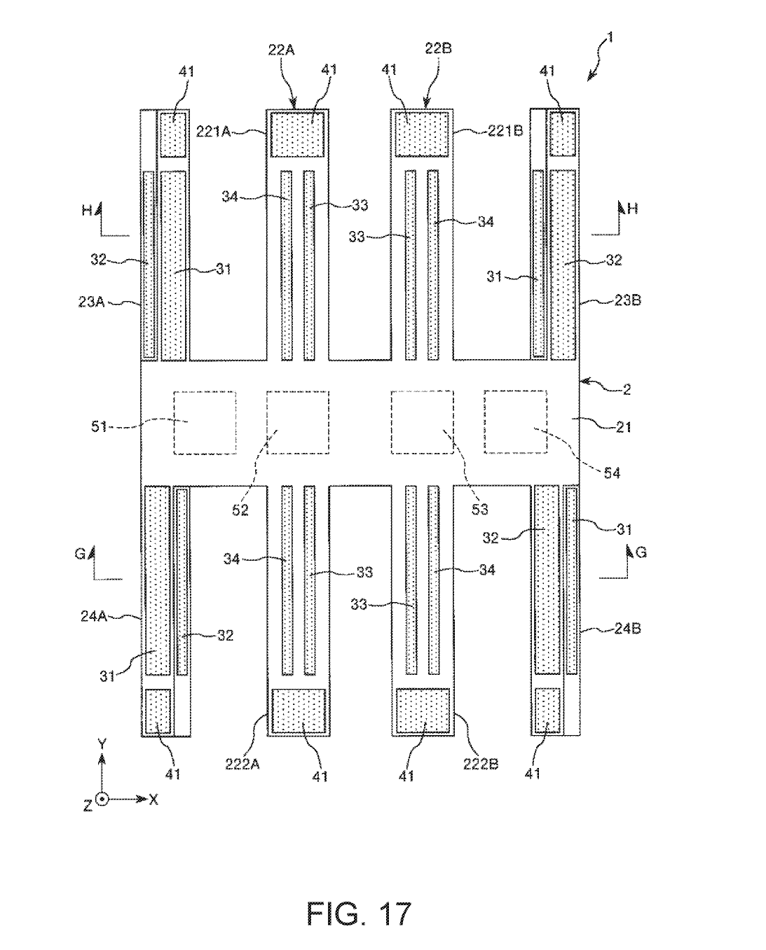

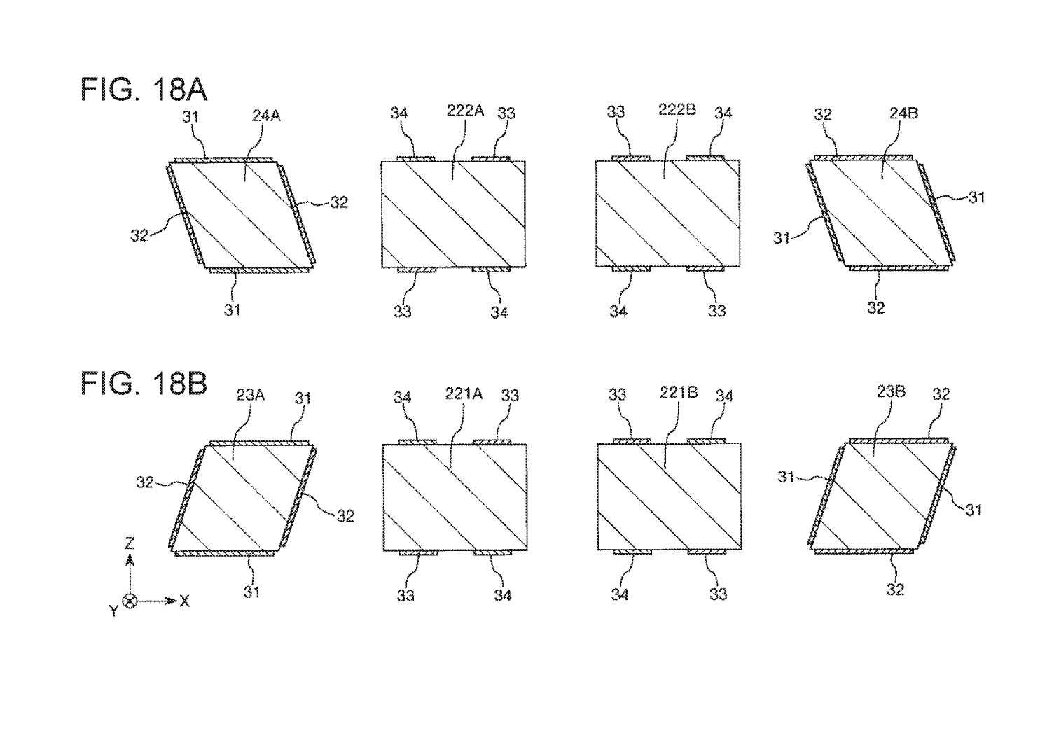

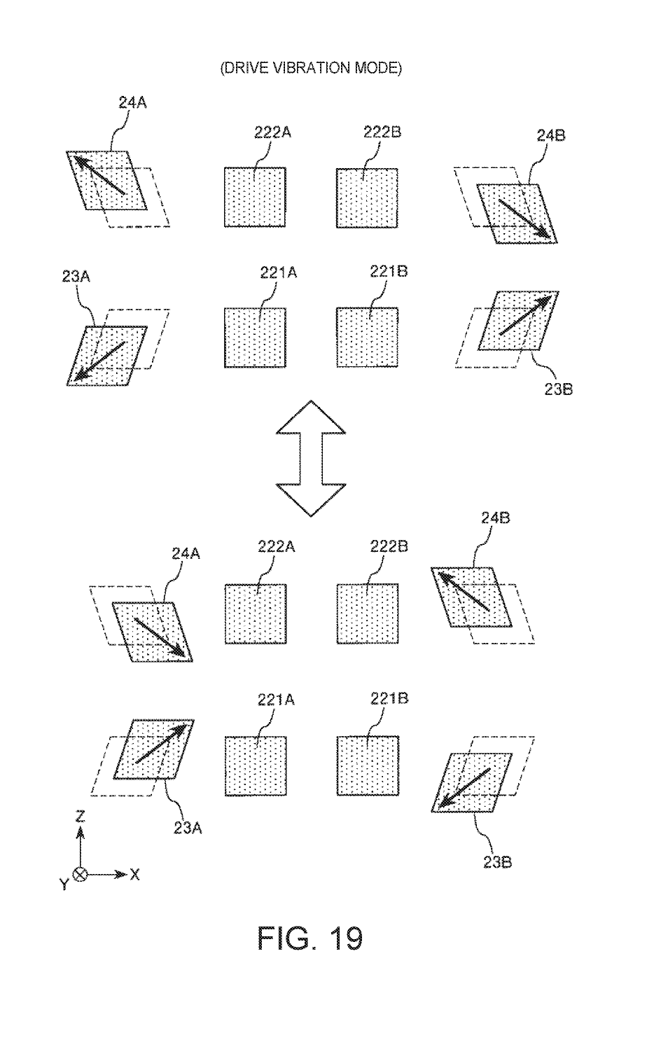

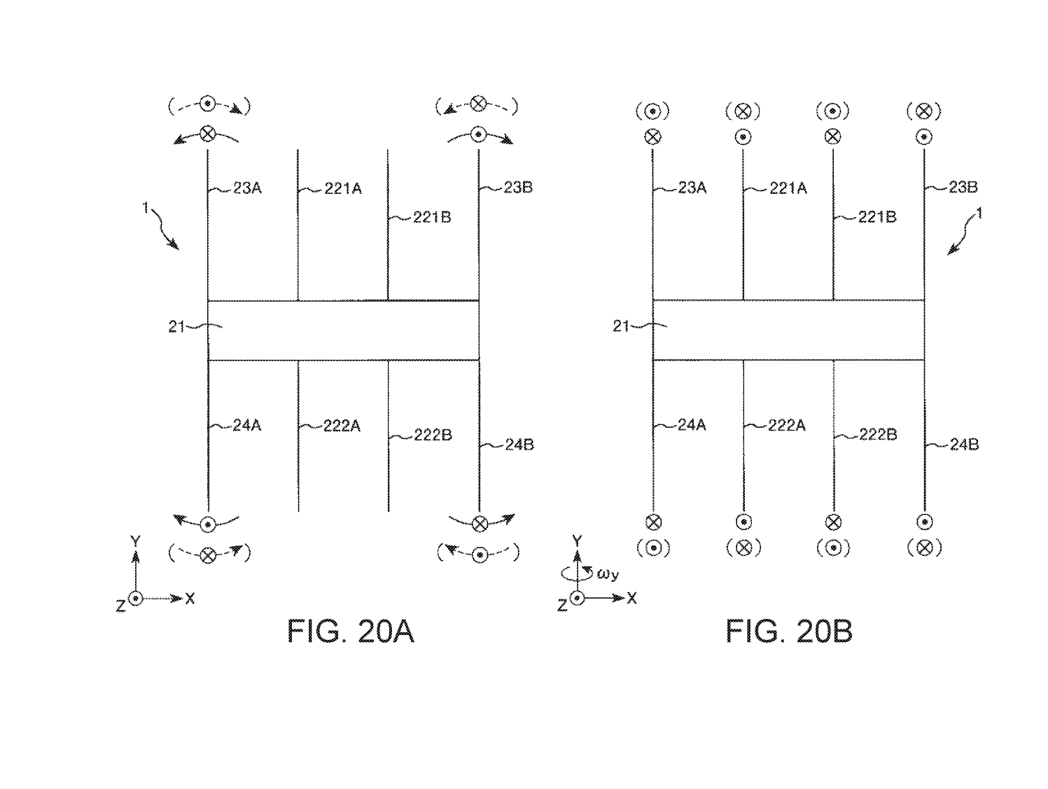

FIG. 17 is a plan view showing a gyro element (an angular velocity detection element) according to a sixth embodiment of the invention. FIG. 18A is a cross-sectional view along the line G-G in FIG. 17, and FIG. 18B is a cross-sectional view along the line H-H in FIG. 17. FIG. 19 is a diagram showing the drive vibration mode of the gyro element shown in FIG. 17. FIG. 20A is a schematic diagram showing the drive vibration mode, and FIG. 20B is a schematic diagram showing the detection vibration mode.

The sixth embodiment will hereinafter be described mainly focusing on the differences from the embodiments described above, and the explanation of substantially the same matters will be omitted.

The sixth embodiment is substantially the same as the third embodiment described above except the point that the positions of the detection sections and the drive arms are different. It should be noted that in FIGS. 17, 18A, 18B, 19, 20A, and 20B, the constituents substantially identical to those of the embodiment described above are denoted by the same reference symbols.

As shown in FIG. 17, in the gyro element 1 according to the present embodiment, the drive arms 23A, 24A extend from an end portion on the −X-axis side of the base section 21 toward both sides in the Y-axis direction, and the drive arms 23B, 24B extend from an end portion on the +X-axis side of the base section 21 toward both sides in the Y-axis direction. Among these drive arms, the drive arms 23A, 23B extend toward the +Y-axis side, and the drive arms 24A, 24B extend toward the −Y-axis side. Further, the drive arms 23A, 24A and the drive arms 23B, 24B are disposed symmetrically to the Y-Z plane, and the drive arms 23A, 23B and the drive arms 24A, 24B are disposed symmetrically to the base section 21.

Further, the detection section 22A has a pair of detection arms 221A, 222A extending from the base section 21 toward the both sides in the Y-axis direction, and the detection section 22B has a pair of detection arms 221B, 222B extending from the base section 21 toward the both sides in the Y-axis direction. Among these detection arms, the detection arms 221A, 221B extend on the +Y-axis side, and are located between the drive arms 23A, 23B. Further, the detection arms 222A, 222B extend on the −Y-axis side, and are located between the drive arms 24A, 24B. Further, the detection sections 22A, 22B are disposed symmetrically to the Y-Z plane.

As shown in FIGS. 18A and 18B, on each of the upper surfaces and the lower surfaces of the detection arms 221A, 222A, there are disposed the detection signal electrode 33 and the detection ground electrode 34 arranged in the X-axis direction. On the upper surface of each of the detection arms 221A, 222A, the detection ground electrode 34 is located on the −X-axis side of the detection signal electrode 33, and on the lower surface, the detection ground electrode 34 is located on the +X-axis side of the detection signal electrode 33.

Similarly, on each of the upper surfaces and the lower surfaces of the detection arms 221B, 222B, there are disposed the detection signal electrode 33 and the detection ground electrode 34 arranged in the X-axis direction. On the upper surface of each of the detection arms 221B, 222B, the detection ground electrode 34 is located on the +X-axis side of the detection signal electrode 33, and on the lower surface, the detection ground electrode 34 is located on the −X-axis side of the detection signal electrode 33.

These detection signal electrodes 33 are each connected to the detection signal terminal 53 via wiring not shown, and the detection ground electrodes 34 are each connected to the detection ground terminal 54 via wiring not shown.

Further, as shown in FIGS. 18A and 18B, the drive arms 23A, 24A, 23B, and 24B are each provided with the drive signal electrodes 31 and the drive ground electrodes 32. The drive signal electrodes 31 are disposed on both principal surfaces of each of the drive arms 23A, 24A, and both side surfaces of each of the drive arms 23B, 24B, and the drive ground electrodes 32 are disposed on both side surfaces of each of the drive arms 23A, 24A, and both principal surfaces of each of the drive arms 23B, 24B. These drive signal electrodes 31 are each connected to the drive signal terminal 51 via wiring not shown, and the drive ground electrodes 32 are each connected to the drive ground terminal 52 via wiring not shown.

Such a gyro element 1 vibrates in the drive vibration mode shown in FIGS. 19 and 20A. Specifically, the drive arms 23A, 24A vibrate in the X-axis in-phase mode, and the drive arms 23B, 24B vibrate in the X-axis in-phase mode, and the drive arms 23A, 24A and the drive arms 23B, 24B vibrate in the X-axis inverse-phase mode. Further, coupling to such vibrations in the X-axis direction, the drive arms 23A, 24B vibrate in the Z-axis in-phase mode, and the drive arms 24A, 23B vibrate in the Z-axis in-phase mode, and the drive arms 23A, 24B and the drive arms 24A, 23B vibrate in the Z-axis inverse-phase mode. In the state in which the gyro element 1 is vibrated in the drive vibration mode, the vibrations in the Z-axis direction of the drive arms 23A, 24A, 23B, and 24B are canceled, and thus, the detection arms 221A, 222A, 221B, and 222B each hardly vibrate in the Z-axis direction. Therefore, the detection signal taken out between the detection signal terminal 53 and the detection ground terminal 54 is approximately 0 (zero).

When the angular velocity ωy around the Y axis is applied to the gyro element 1 in the state of the drive vibration mode, the Coriolis force acts to newly excite the vibration in the detection vibration mode as shown in FIG. 20B. Specifically, the drive arms 23A, 24A vibrate in the Z-axis in-phase mode, and the drive arms 23B, 24B vibrate in the Z-axis in-phase mode, and the drive arms 23A, 24A and the drive arms 23B, 24B vibrate in the Z-axis inverse-phase mode. Further, due to such vibrations of the drive arms 23A, 24A, 23B, and 24B, the detection arms 221A, 222A vibrate in the Z-axis in-phase mode, the detection arms 221B, 222B vibrate in the Z-axis in-phase mode, and the detection arms 221A, 222A and the detection arms 221B, 222B vibrate in the Z-axis inverse-phase mode. Therefore, the charges with the same phase are generated from the detection arms 221A, 222A, 221B, and 222B, and the detection signal SS obtained by adding these charges to each other is taken out between the detection signal terminal 53 and the detection ground terminal 54. Then, the angular velocity ωy is obtained based on the detection signal SS.

As described above, in the present embodiment, since the detection signal SS can be increased roughly fourfold compared to the first embodiment due to the charges from the detection arms 221A, 222A, 221B, and 222B, the gyro element 1 higher in detection accuracy is achieved. Further, according to the present embodiment, since the vibrations in the X-axis direction and the Z-axis direction of the drive arms 23A, 24A, 23B, and 24B, and the detection arms 221A, 222A, 221B, and 222B can be canceled in the drive vibration mode and the detection vibration mode, the vibration leakage of the gyro element 1 can be reduced, and thus, the detection accuracy is further improved.

According also to such a sixth embodiment as described above, substantially the same advantages as in the first embodiment described above can be exerted.

### 2. Angular Velocity Detection Device

Then, an angular velocity detection device using the gyro element 1 will be described.

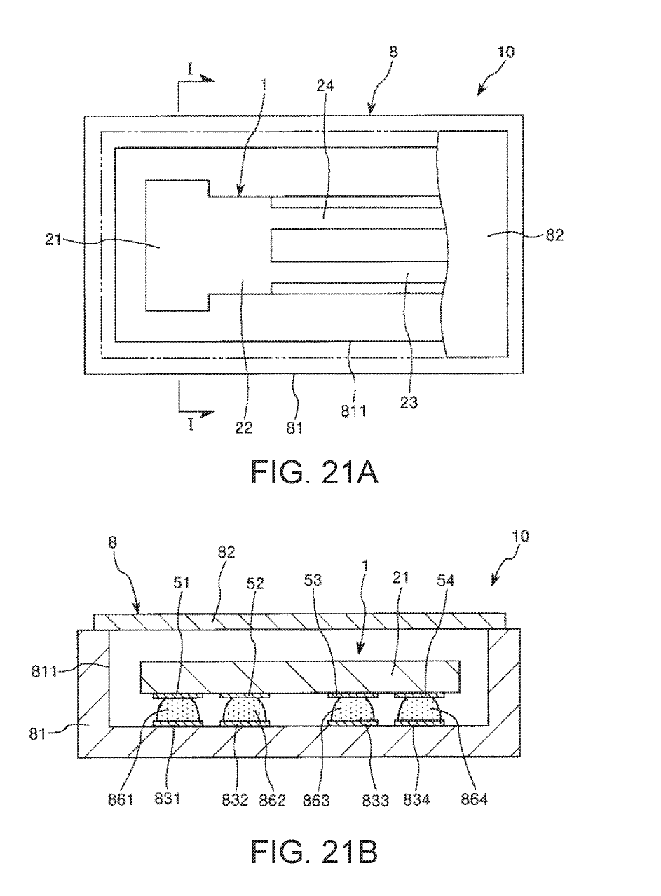

FIGS. 21A and 21B are diagrams showing the angular velocity detection device according to a preferred embodiment of the invention, wherein FIG. 21A is a plan view, and FIG. 21B is a cross-sectional view along the line I-I in FIG. 21A.

As shown in FIGS. 21A and 21B, the angular velocity detection device 10 has the gyro element 1, and a package 8 for housing the gyro element 1.

The package 8 has a base 81 having a box-like shape provided with a recessed section 811, and a lid 82 having a plate-like shape and bonded to the base 81 so as to block the opening of the recessed section 811. Further, the gyro element 1 is housed in a housing space formed by the recessed section 811 blocked by the lid 82. The housing space can be kept in a reduced-pressure (vacuum) state, or filled with an inert gas such as nitrogen, helium, or argon.

The constituent material of the base 81 is not particularly limited, but a variety of types of ceramics such as aluminum oxide or a variety of types of glass materials can be used therefor. Further, the constituent material of the lid 82 is not particularly limited, but a member with a linear expansion coefficient similar to that of the constituent material of the base 81 is preferable. For example, if the ceramics described above is used as the constituent material of the base 81, an alloy such as kovar is preferably used. It should be noted that bonding between the base 81 and the lid 82 is not particularly limited, but it is possible to adopt bonding with, for example, an adhesive or a brazing material.

Further, on the bottom surface of the recessed section 811, there are formed connection terminals 831, 832, 833, and 834. These connection terminals 831 through 834 are each drawn to the lower surface (the outer peripheral surface of the package 8) of the base 81 using through electrodes (through holes) or the like not shown provided to the base 81.

In the gyro element 1, the base section 21 is fixed to the bottom surface of the recessed section 811 with electrically-conductive adhesives 861, 862, 863, and 864. Further, the drive signal terminal 51 and the connection terminal 831 are electrically connected to each other via the electrically-conductive adhesive 861, the drive ground terminal 52 and the connection terminal 832 are electrically connected to each other via the electrically-conductive adhesive 862, the detection signal terminal 53 and the connection terminal 833 are electrically connected to each other via the electrically-conductive adhesive 863, and the detection ground terminal 54 and the connection terminal 834 are electrically connected to each other via the electrically-conductive adhesive 864. The electrically-conductive adhesives 861 through 864 are not particularly limited providing an electrically-conductive property and an adhesive property are provided, and there can be used a material obtained by dispersing electrically-conductive filler such as silver particles in an adhesive such as a silicone adhesive, an epoxy adhesive, an acrylic adhesive, a polyimide adhesive, or a bismaleimide adhesive.

### 3. Gyro Sensor

Then, a gyro sensor equipped with the gyro element 1 will be described.

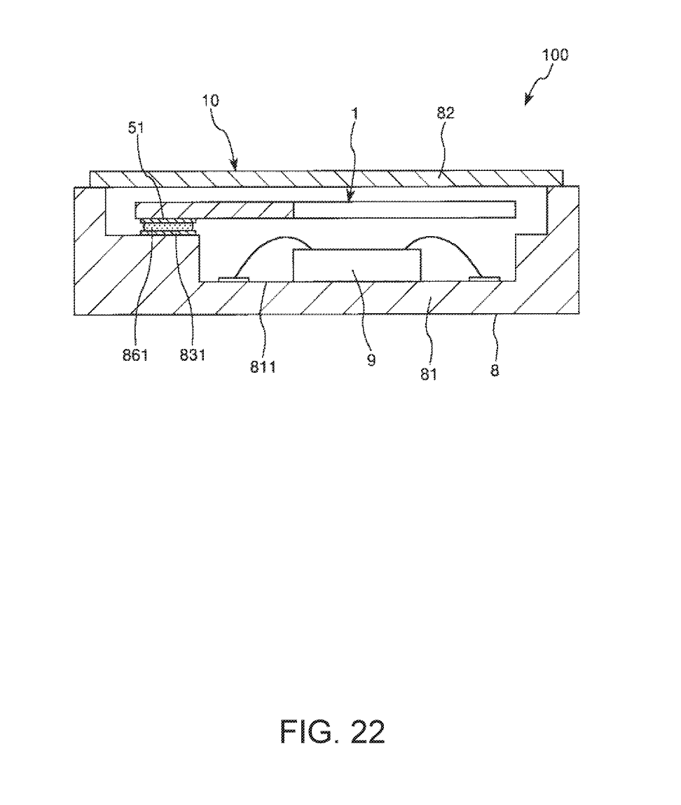

FIG. 22 is a cross-sectional view showing the gyro sensor as a preferred embodiment of the invention.

As shown in FIG. 22, the gyro sensor 100 has an angular velocity detection device 10 and an IC chip 9. The IC chip 9 is fixed to the bottom surface of the recessed section 811 with a brazing material or the like. The IC chip 9 is electrically connected to the connection terminals 831 through 834 with electrically-conductive wires (it should be noted that in FIG. 22, only the connection terminal 831 is illustrated). Such an IC chip 9 has a drive circuit for making the gyro element 1 perform the drive vibration, a detection circuit for detecting the detection vibration caused in the gyro element 1 in response to the angular velocity applied thereto, and so on. It should be noted that although in the present embodiment, the IC chip 9 is disposed inside the package 8, it is also possible for the IC chip 9 to be disposed outside the package 8.

### 4. Electronic Apparatus

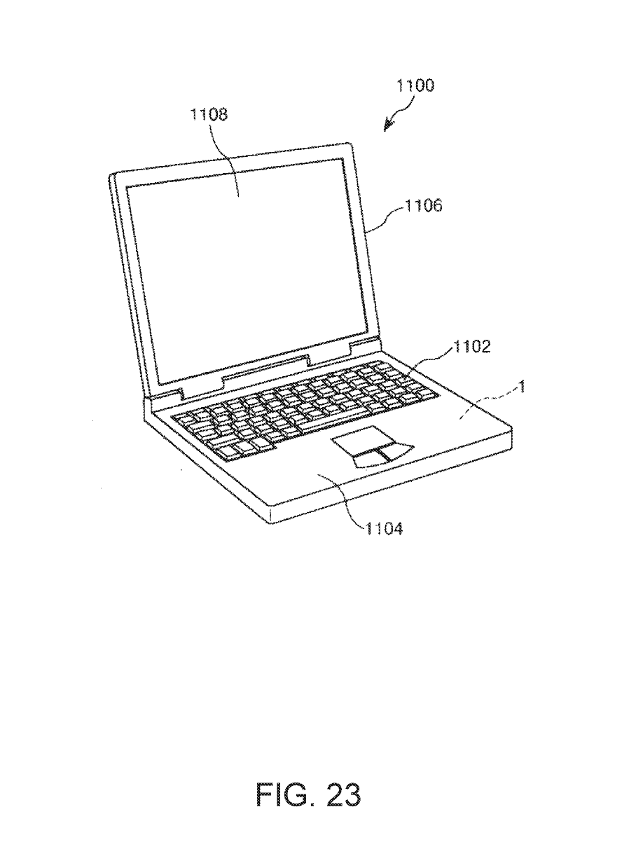

Then, an electronic apparatus equipped with the gyro element 1 will be described in detail with reference to FIGS. 23 through 25.

FIG. 23 is a perspective view showing a configuration of a mobile type (or laptop type) personal computer as the electronic apparatus according to the invention.

In the drawing, the personal computer 1100 includes a main body section 1104 provided with a keyboard 1102, and a display unit 1106 provided with a display section 1108, and the display unit 1106 is pivotally supported with respect to the main body section 1104 via a hinge structure. Such a personal computer 1100 incorporates the gyro element 1 functioning as an angular velocity sensor (a gyro sensor).

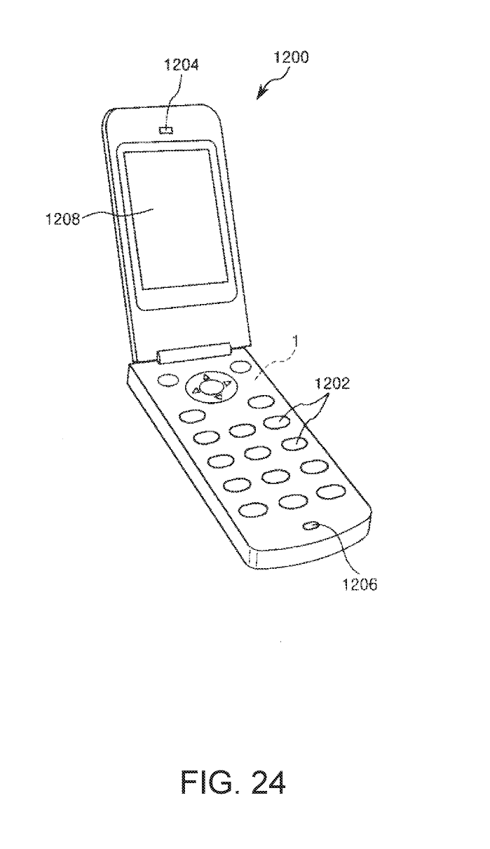

FIG. 24 is a perspective view showing a configuration of a cellular phone (including a smartphone, PHS and so on) as the electronic apparatus according to the invention.

In this drawing, the cellular phone 1200 is provided with a plurality of operation buttons 1202, an ear piece 1204, and a mouthpiece 1206, and a display section 1208 is disposed between the operation buttons 1202 and the ear piece 1204. Such a cellular phone 1200 incorporates the gyro element 1 functioning as an angular velocity sensor (a gyro sensor).

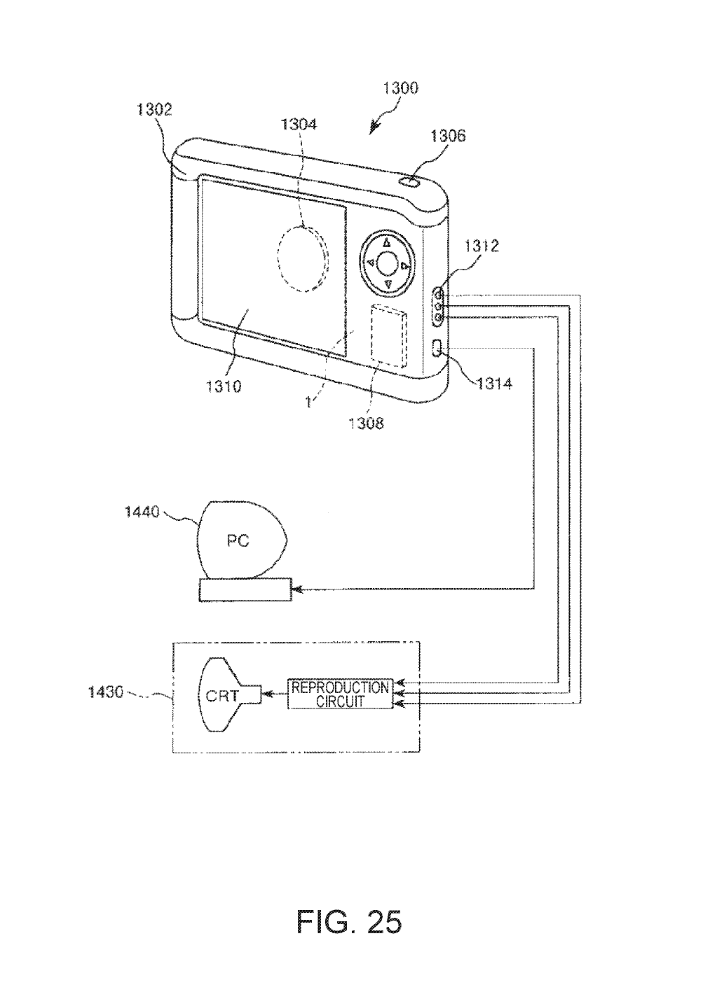

FIG. 25 is a perspective view showing a configuration of a digital still camera as the electronic apparatus according to the invention. It should be noted that the connection with external equipment is also shown briefly in this drawing.

The digital still camera 1300 performs photoelectric conversion on an optical image of an object using an imaging element such as a CCD (Charge Coupled Device) to thereby generate an imaging signal (an image signal). A case (a body) 1302 of the digital still camera 1300 is provided with a display section 1310 disposed on the back surface of the case 1302 to provide a configuration of performing display in accordance with the imaging signal from the CCD, wherein the display section 1310 functions as a viewfinder for displaying the object as an electronic image.

Further, the front surface (the back side in the drawing) of the case 1302 is provided with a light receiving unit 1304 including an optical lens (an imaging optical system), the CCD, and so on.

When the photographer checks an object image displayed on the display section 1310, and then holds down a shutter button 1306, the imaging signal from the CCD at that moment is transferred to and stored in a memory device 1308.

Further, the digital still camera 1300 is provided with video signal output terminals 1312 and an input/output terminal 1314 for data communication disposed on a side surface of the case 1302. Further, as shown in the drawing, a television monitor 1430 and a personal computer 1440 are respectively connected to the video signal output terminals 1312 and the input-output terminal 1314 for data communication according to needs. Further, there is adopted the configuration in which the imaging signal stored in the memory device 1308 is output to the television monitor 1430 and the personal computer 1440 in accordance with a predetermined operation.

Such a digital still camera 1300 incorporates the gyro element 1 functioning as an angular velocity sensor (a gyro sensor).

The electronic apparatuses described above are each provided with the gyro element 1, and can therefore exert high reliability.

It should be noted that, as the electronic apparatus according to the invention, there can be cited, for example, a smartphone, a tablet terminal, an inkjet ejection device (e.g., an inkjet printer), a laptop personal computer, a television set, a video camera, a video cassette recorder, a car navigation system, a pager, a personal digital assistance (including one with communication function), an electronic dictionary, an electric calculator, a computerized game machine, a word processor, a workstation, a video phone, a security video monitor, a pair of electronic binoculars, a POS terminal, a medical device (e.g., an electronic thermometer, an electronic manometer, an electronic blood sugar meter, an electrocardiogram measurement instrument, an ultrasonograph, and an electronic endoscope), a fish detector, various types of measurement instruments, various types of gauges (e.g., gauges for a vehicle, an aircraft, or a ship), and a flight simulator, besides the personal computer (the mobile personal computer) shown in FIG. 23, the cellular phone shown in FIG. 24, and the digital still camera shown in FIG. 25.

### 5. Moving Object

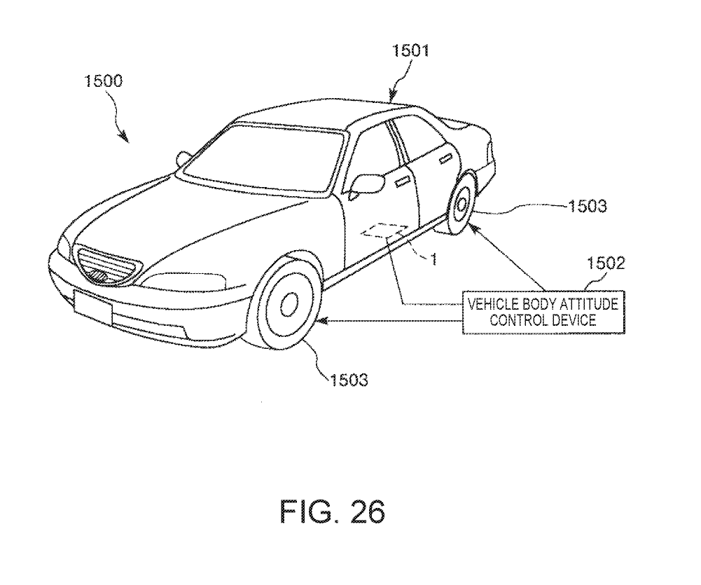

Then, a moving object equipped with the gyro element 1 shown in FIG. 1 will be described in detail with reference to FIG. 26.

FIG. 26 is a perspective view showing a configuration of a vehicle as a moving object according to the invention.

The vehicle 1500 incorporates the gyro element 1 functioning as the angular velocity sensor (the gyro sensor), and the attitude of a vehicle body 1501 can be detected using the gyro element 1. The detection signal of the gyro element 1 is supplied to the vehicle body attitude control device 1502, and the vehicle body attitude control device 1502 detects the attitude of the vehicle body 1501 based on the detection signal, and it is possible to control the stiffness of the suspension or control the brake of each of wheels 1503 in accordance with the detection result. Besides the above, such posture control as described above can be used for a two-legged robot and a radio control helicopter. As described above, in realizing the posture control of a variety of types of moving objects, the gyro element 1 is incorporated.

Although the angular velocity detection element, the angular velocity detection device, the electronic apparatus, and the moving object according to the invention are described based on the embodiments shown in the accompanying drawings, the invention is not limited to these embodiments, but the constituents of each of the sections can be replaced with those having an identical function and an arbitrary configuration. Further, it is also possible to add any other constituents to the invention. Further, the invention can be a combination of any two or more configurations (features) of the embodiments described above.

Further, although in the angular velocity detection element described above, the piezoelectric substrate is used, the invention is not limited to the piezoelectric substrate, but it is also possible to use a semiconductor substrate such as a silicon substrate. In this case, it is possible to form piezoelectric elements or the like on the silicon substrate to vibrate the drive arms due to the expansion and the contraction of the piezoelectric elements.

The entire disclosure of Japanese Patent Application No. 2015-059146, filed Mar. 23, 2015 is expressly incorporated by reference herein.

What is claimed is:

1. An angular velocity detection element comprising:
a base section;
at least two drive arms connected to the base section; and
a detection section adapted to detect an angular velocity applied in a state in which the two drive arms are flexurally vibrated in a drive vibration mode,
wherein in the drive vibration mode, the two drive arms flexurally vibrate in phase in an in-plane direction of the base section, and flexurally vibrate in reverse phase along a thickness direction that is crossing the in-plane direction.

2. The angular velocity detection element according to claim 1, wherein
the two drive arms are tilted so that a distance between the two drive arms increases toward a tip side of the drive arms.

3. The angular velocity detection element according to claim 1, comprising:
a first vibrating system and a second vibrating system each having the detection section and the two drive arms,
wherein in the drive vibration mode, the two drive arms of the first vibrating system and the two drive arms of the second vibrating system flexurally vibrate in reverse phase in the in-plane direction.

4. The angular velocity detection element according to claim 3, wherein
the drive arm of the first vibrating system located on the second vibrating system side, and the drive arm of the second vibrating system located on the first vibrating system side flexurally vibrate in reverse phase in the thickness direction of the base section in the drive vibration mode.

5. The angular velocity detection element according to claim 1, wherein
the detection section is disposed between the base section and the two drive arms.

6. The angular velocity detection element according to claim 1, wherein
the detection section is disposed on an opposite side to the drive arms with respect to the base section.

7. An angular velocity detection device comprising:
the angular velocity detection element according to claim 1; and
a package adapted to house the angular velocity detection element.

8. An angular velocity detection device comprising:
the angular velocity detection element according to claim 2; and
a package adapted to house the angular velocity detection element.

9. An angular velocity detection device comprising:
the angular velocity detection element according to claim 3; and
a package adapted to house the angular velocity detection element.

10. An angular velocity detection device comprising:
the angular velocity detection element according to claim 4; and
a package adapted to house the angular velocity detection element.

11. An angular velocity detection device comprising:
the angular velocity detection element according to claim 5; and
a package adapted to house the angular velocity detection element.

12. An electronic apparatus comprising:
the angular velocity detection element according to claim 1.

13. An electronic apparatus comprising:
the angular velocity detection element according to claim 2.

14. An electronic apparatus comprising:
the angular velocity detection element according to claim 3.

15. An electronic apparatus comprising:
the angular velocity detection element according to claim 4.

16. An electronic apparatus comprising:
the angular velocity detection element according to claim 5.

17. A moving object comprising:
the angular velocity detection element according to claim 1.

18. A moving object comprising:
the angular velocity detection element according to claim 2.

19. A moving object comprising:
the angular velocity detection element according to claim 3.

20. A moving object comprising:
the angular velocity detection element according to claim 4.
